(19) United States
(12) Patent Application Publication
(10) Pub. No.: US 2022/0043539 A1
(43) Pub. Date: Feb. 10, 2022

(54) SYSTEM AND METHOD FOR INTELLIGENT REVIEW, PROCESSING AND REPORTING OF FINANCIAL DATA

(71) Applicant: KPMG LLP, New York, NY (US)

(72) Inventors: Brad L. Brown, Pacific Palisades, CA (US); Sean Daniel Bloodwell, Garnet Valley, PA (US); Travis Lee Garlock, Henrico, VA (US); Lisa Maestrale Giffin, Williamstown, NJ (US); Kenjiro James Ono, Stewart Manor, NY (US); Zubin Patel, Chamblee, GA (US); Steven K. Rainey, Vienna, VA (US)

(21) Appl. No.: 17/229,562

(22) Filed: Apr. 13, 2021

Related U.S. Application Data
(60) Provisional application No. 63/063,048, filed on Aug. 7, 2020.

(51) Int. Cl. G06F 3/0481; G06N 5/04; G06N 20/00; G06Q 10/10; G06Q 40/00; G06Q 40/06

(52) U.S. Cl. CPC G06F 3/0481; G06N 5/04; G06N 20/00; G06Q 50/26; G06Q 40/123; G06Q 40/06; G06Q 40/10; G06Q 10/10

(57) ABSTRACT

An intelligent review and processing system and associated method for receiving financial data from one or more data sources, processing and storing the financial data, and generating one or more reports from the financial data with a report generator. The report generator includes a user interface generator for generating a plurality of user interfaces having a window element that includes a navigation pane formed along a left side of the window element having an actuatable soft button for accessing one or more portions of a tax review sequence having a plurality of tax review steps, a top pane element for displaying tip information, and a bottom pane element for displaying information associated with one or more of the plurality of tax review steps. The one or more of the plurality of user interfaces has a window element that includes a graphical element representative of the plurality of tax review steps.

### RELATED APPLICATION

This application claims priority to U.S. Provisional patent application Ser. No. 63/063,048, entitled System And Method For Intelligent Review, Processing And Reporting Of Financial Data, filed on Aug. 7, 2020, the contents of which are herein incorporated by reference.

### BACKGROUND OF THE INVENTION

Tax preparation is a time-consuming and laborious process. It is estimated that individuals and businesses spend around 6.1 billion hours per year complying with the filing requirements of various tax authorities. Conventional systems and methods exist that allow entities, such as companies, to aggregate financial data, and then process and utilize the financial data as part of various state and federal tax returns or filings. Conventional systems and methods rely oftentimes on the experience of tax professionals to understand the financial data and to properly and accurately organize and report the financial data. The tax professionals also need to understand the importance of selected types of financial data and how the data affects certain portions of the related tax filing. More specifically, the tax professional oftentimes needs to review voluminous amounts of tax related financial data, and then needs to understand the tax treatment and ramifications of the various types of data.

Conventional financial data processing systems and methods, however, have significant drawbacks. For example, the process associated with the preparation of tax returns is oftentimes highly dependent upon the skill and experience of the tax professional. Thus, the quality of the tax returns tends to vary between tax professionals. Also, the current conventional systems do not necessarily identify areas of the tax return that may be impacted by selected types of financial data or that require further review by the tax professional. As such, these important areas may be inadvertently missed or not sufficiently reviewed by the tax professional, thus impacting the overall quality and reliability of the tax filing.

Conventional tax preparation software has been commercially available to assist professionals in preparing tax returns for clients, such as businesses and companies. Traditionally, the tax professional navigates through a set of rigidly defined user interface screens that selectively ask pre-determined questions that are relevant to a particular tax topic or data field needed to calculate a taxpayer's tax liability. The user typically provides or enters relevant financial data into the various fields, and then the system automatically generates the tax return. More specifically, these prior tax return preparation systems use fixed forms having a fixed order of fields to be completed, and/or an unguided input and review process, that present to the user as static features of the overall tax return preparation system. While these prior tax return preparation systems are useful, they are also structured with a fixed, predetermined and/or pre-packaged structure or sequence of questions that are presented to all users as part of the forms filling or interview process, without regard to the financial nuances of the company.

Consequently, the conventional systems are not capable of sufficiently enabling the tax professionals to effectively analyze the aforementioned financial nuances of each company to understand the appropriate tax treatment and to accurately report the information in the tax returns. Further, while traditional tax return preparation applications may be comprehensive, they do not allow an easy and efficient way of informing a user of form fields and/or tax data needed to complete a tax return, or to navigate from one required form field to the next required form field, especially when navigating between required form fields on different forms. This has a number of negative consequences including, for example, increased time and computing resources required to prepare an electronic tax return, user confusion, an inability to proactively identify sources of financial data that may require further review, and the like. Other drawbacks of these traditional systems is that they do not sufficiently flag aberrant financial data and do not serve as a proper training tool for younger tax professionals.

### SUMMARY OF THE INVENTION

The present invention is thus directed to a system and method for processing, reporting, and displaying financial data. More particularly, the system and method of the present invention employs a user interface (UI) generator for generating a series of user interfaces or windows that display certain selected fields having actuatable tab elements and soft buttons for processing and displaying financial data, as part of the tax preparation process. The windows can be employed by a user of the system (e.g., a tax professional) in preparing one or more tax returns or filings. The windows can be structured, organized and arranged so as to display relevant portions of the financial data that correspond to selected portions of the tax return, and to guide the tax professional through a structured series or sequence of steps when preparing the tax return. The system can also employ associated diagnostics that analyze the financial data for selected patterns that the tax reviewer can review in order to flag potential issues. The system and method can also identify through the sequence of windows selected portions of the financial data that may need to be further reviewed, as well as provide review tips to the user when employing or reviewing the displayed portion of the tax return.

The present invention is directed to an intelligent review and processing system comprising one or more sources of financial data, an electronic device for processing and storing the financial data, and a report generator for generating one or more reports from the financial data. The report generator has a user interface generator for generating a plurality of user interfaces each having a window element that displays selected portions of the processed financial data. The window element of the user interfaces includes a navigation pane formed along a left side of the window element having an actuatable soft button for accessing one or more portions of a tax review sequence having a plurality of tax review steps, a top pane element for displaying tip information and associated guidance, and a bottom pane element for displaying information associated with one or more of the plurality of tax review steps. The user interfaces also include a window element that has a graphical element representative of the plurality of tax review steps.

The graphical element includes a graphical timeline element having a plurality of waypoint elements associated therewith, and each of the plurality of waypoint elements has a step icon element representative of one of the plurality of tax review steps. Further, each of the step icon elements has associated therewith an actuatable soft button. The graphical element can include a circular graphical element and an associated counter element representative of the selected tax review step. The circular graphical element can include a highlight graphical element for visually highlighting a selected portion of the circular graphical element.

The window element further comprises a header pane that is disposed or located at a topmost portion of the window element.

The step icon elements and the navigation pane, when the associated soft button is actuated, can include for display in the window one or more of, or any combination of, a Step 1 View Current Year Transactions step icon element for displaying, when actuated, financial data related to current year transactions and deliverables of a company; a Step 2 View Accounts Analysis step icon element for displaying, when actuated, financial data related to a taxable income of the company; a Step 3 View Financial Statement Reconciliation step icon element for displaying when actuated financial data associated with a tax return of the company; a Step 4 View Federal Tax Income Activity step icon element for displaying when actuated financial data associated with the taxable income, earnings, and profits of the company; a Step 5 View US International Calculations and Reports step icon element for displaying when actuated financial data associated with one or more selected workbooks; a Step 6 View Federal Tax Return step icon element for displaying when actuated the tax return of the company; and a Step 7 View State Taxable Income and Returns step icon element for displaying when actuated financial data related to state related financial information. Further, each of the step icon elements is associated with a respective one of the plurality of waypoint elements.

According to another aspect, the actuatable soft button associated with each of the step icon elements comprises an actuatable Start soft button for displaying, when actuated, one or more of the user interfaces associated with the tax review step associated therewith.

The system of the present invention can also include a back navigation icon element disposed adjacent to the circular graphical element for navigating through the plurality of tax review steps in a descending order, and a forward navigation icon element disposed opposite to the back navigation icon element for navigating through the plurality of tax review steps in an ascending order. The window element of the system can also include a hideable navigation bar that is disposed on a bottommost portion thereof and below and adjacent to the bottom pane element. The navigation bar can include a plurality of navigation icons, where each of the navigation icons corresponds to each of the plurality of tax review steps. The navigation bar is hideable by selecting a soft button associated with the navigation bar.

The system can further include a menu box that is displayed in the window element when the actuatable soft button in the navigation pane is actuated by a user, where the menu box displays the plurality of tax review steps.

According to another aspect, the top pane element includes an actuatable filter button that allows the user to select one or more data filters from a list of data filters, and the bottom pane element displays information associated with each of the plurality of tax review steps, where one or more of the plurality of tax review steps includes a plurality of actuatable tab elements. As such, when the Step 1 View Current Year Transactions step icon element is actuated, the bottom pane element displays the plurality of tab elements, and the plurality of tab elements includes one or more of: a Current Year Transactions tab element that allows the user to document and analyze a current year transaction data portion of the financial data; an Entity Change Analysis tab element that allows the user to review changes to the entity structure of the company and to analyze any impact of the changes; a Deliverables Analysis tab element that allows the user to review the completeness and accuracy of a deliverables portion of the financial data; an Acquisition Method Accounting tab element that allows the user to review acquisition information that affects a tax obligation of the company; and an Equity Movement tab element that allows the user to review and analyze equity activity of the company. Further, when the Entity Change Analysis tab element is actuated, the bottom pane element displays a plurality of sub-tab elements comprising one or more of: a Refresh Report sub-tab element for refreshing information within one or more reports generated by the report generator; a View sub-tab element for viewing one or more selectable fields for applying an associated filter to the financial data; a Compare PY Return to CY Return sub-tab element for comparing the financial data in a current year tax return to financial data in a prior year tax return; and a Compare CY Provision to CY Return sub-tab element for allowing the user to compare the financial data in the current year tax return with the financial data in a selected tax income provision. Still further, when the View sub-tab element is actuated, the pane element displays a drop down menu that includes a plurality of selectable fields indicative of information related to the entity structure.

The plurality of selectable fields includes one or more of an entity name field, entity type field, new entities field, terminated entities field, ownership field, and a functional currency field. Also, the drop down menu includes a plurality of action buttons.

According to the present invention, when the Deliverables Analysis tab element is actuated, the bottom pane element displays a plurality of sub-tab elements comprising a Potential Nexus Activity report tab element for displaying financial data associated with state apportionment activity, and a Changes to Filing Group report tab element for comparing and displaying information associated with one or more entities of a company of a current calendar year with similar data from a prior selected year. Similarly, when the Acquisition Method Accounting tab element is actuated, the bottom pane element displays a plurality of sub-tab elements comprising a Temporary Difference sub-tab element for displaying information associated with an acquisition method accounting of the company, and an Impact on Permanent Differences sub-tab element for displaying information associated with transaction costs and book tax differences of the company.

According to the present invention, when the Equity Movement tab element is actuated, the bottom pane element displays a plurality of sub-tab elements comprising one or more of: a Summary of retained Earnings Activity sub-tab element for displaying financial data associated with retained earnings of the company; a Summary of Additional Paid in Capital Activity sub-tab element for displaying financial data related to capital of the company; a Summary of the Common Stock Activity sub-tab element for displaying financial data related to common stock of the company; a Summary of the Preferred Stock Activity sub-tab element for displaying financial data related to preferred stock of the company; and a Summary of Treasury Stock Activity sub-tab element for displaying financial data associated with activity involving treasury stock.

The invention also provides for when the Step 2 View Accounts Analysis step icon element is actuated the bottom pane element displays a second plurality of tab elements, the second plurality of tab elements includes one or more of: a New Accounts tab element for displaying when actuated selected portions of the financial data related to new general ledger accounts of the company; an Incomplete Mappings tab element for displaying when actuated one or more accounts where an analysis of the accounts has not yet been completed; a Deleted Accounts tab element for displaying when actuated the one or more accounts in a prior year tax return or provision that are absent from a current year tax return; a Change in Mappings tab element for displaying when actuated the one or more accounts of the company that has mapping changes; a Complete Mappings tab element for displaying when actuated one or more accounts of the company that have been mapped and displaying details associated with the mapping; and a Standard BTD Mapping tab element.

When the Step 3 View Financial Statement Reconciliation step icon element is actuated, the bottom pane element displays a third plurality of tab elements, and the third plurality of tab elements includes an Exchange Rate Workbook report tab element for displaying, when actuated, information associated with exchange rates being employed in a project employing the tax steps and used for translating financial data into one or more foreign currencies, an Adjusting Journal Entries report tab element for displaying one or more of the journal entries in the project, and a Financial Statement Reconciliation report tab element for displaying when actuated any differences between financial data entries in the workbook with selected financial data in the tax return. Further, when the Step 4 View Federal Tax Income Activity step icon element is actuated, the bottom pane element displays a fourth plurality of tab elements that includes one or more of: a Diagnostics tab element for displaying, when actuated, the financial data employed to determine a taxable income, earnings and profit of the company and for allowing the user to review selected patterns in the financial data indicative of one or more errors; a Tax Adjustments Analysis tab element for displaying when actuated the financial data employed to determine a book tax difference of the company and to perform a risk based review of the book tax differences; a Basis Differences tab element for allowing when actuated the user to review and assess an accuracy of a basis difference in the financial data used in the tax return not affecting taxable income of the company; a Taxable Income Reconciliation tab element for displaying when actuated information associated with a reconciliation of the taxable income of the company in comparison to one or more previous income tax provisions; and a Checks and Balances tab element for displaying when actuated selected portions of the tax return of the company to ensure that certain aspects thereof are reconciled.

The present invention is also directed to a computer implemented method, comprising receiving financial data from one or more data sources, processing and storing the financial data, and generating one or more reports from the financial data with a report generator, where the report generator has a user interface generator for generating a plurality of user interfaces each having a window element that displays selected portions of the processed financial data. The window element of one or more of the user interfaces includes a navigation pane formed along a left side of the window element having an actuatable soft button for accessing one or more portions of a tax review sequence having a plurality of tax review steps, a top pane element for displaying tip information and guidance, and a bottom pane element for displaying information associated with one or more of the plurality of tax review steps. The user interfaces can include a window element that includes a graphical element representative of the plurality of tax review steps. The window element can include a header pane that is disposed or located at a topmost portion of the window element.

The graphical element can comprise a graphical timeline element having a plurality of waypoint elements associated therewith, where each of the plurality of waypoint elements has associated therewith a step icon element representative of one of the plurality of tax review steps. Further, each of the step icon elements can have associated therewith an actuatable soft button. Further, when the associated soft button is actuated, one or more of the step icon elements or the navigation pane can include: a Step 1 View Current Year Transactions step icon element for displaying, when actuated, financial data related to current year transactions and deliverables of a company; a Step 2 View Accounts Analysis step icon element for displaying, when actuated, financial data related to a taxable income of the company; a Step 3 View Financial Statement Reconciliation step icon element for displaying when actuated financial data associated with a tax return of the company; a Step 4 View Federal Tax Income Activity step icon element for displaying when actuated financial data associated with the taxable income, earnings, and profits of the company; a Step 5 View US International Calculations and Reports step icon element for displaying when actuated financial data associated with one or more selected workbooks; a Step 6 View Federal Tax Return step icon element for displaying when actuated the tax return of the company; and a Step 7 View State Taxable Income and Returns step icon element for displaying when actuated financial data related to state related financial information. Further, each of the step icon elements can be associated with a respective one of the plurality of waypoint elements.

According to the method of the present invention. the actuatable soft button associated with each of the step icon elements can comprise an actuatable Start soft button for displaying, when actuated, one or more of the user interfaces associated with the tax review step associated therewith. Further, the graphical element can include a circular graphical element and associated counter element representative of the selected tax review step. Still further, the method provides for disposing a back navigation icon element adjacent to the circular graphical element for navigating through the plurality of tax review steps in a descending order, and disposing a forward navigation icon element opposite to the back navigation icon element for navigating through the plurality of tax review steps in an ascending order. Also, the method can provide for disposing a hideable navigation bar on a bottommost portion of the window element and below and adjacent to the bottom pane element, where the navigation bar includes a plurality of navigation icons, and where each of the navigation icons corresponds to each of the plurality of tax review steps. The navigation bar can be selectively hidden by selecting a soft button associated with the navigation bar.

The method also provides for displaying a menu box in the window element when the actuatable soft button in the navigation pane is actuated by a user where the menu box displays the plurality of tax review steps, and providing in the top pane element an actuatable filter button that allows the user to select one or data filters from a list of data filters. The bottom pane element displays information associated with each of the plurality of tax review steps, and one or more of the plurality of tax review steps includes a plurality of actuatable tab elements.

Further, when the Step 1 View Current Year Transactions step icon element is actuated, the bottom pane element displays the plurality of tab elements, and the plurality of tab elements includes one or more of: a Current Year Transactions tab element that allows the user to document and review a current year transaction data portion of the financial data; an Entity Change Analysis tab element that allows the user to review changes to the entity structure of the company and to analyze any impact of the changes; a Deliverables Analysis tab element that allows the user to review the completeness and accuracy of a deliverables portion of the financial data; an Acquisition Method Accounting tab element that allows the user to review acquisition information that affects a tax obligation of the company; and an Equity Movement tab element that allows the user to review and analyze equity activity of the company.

Still further, when the Entity Change Analysis tab element is actuated, the bottom pane element displays a plurality of sub-tab elements comprising one or more of: a Refresh Report sub-tab element for refreshing information within one or more reports generated by the report generator; a View sub-tab element for viewing one or more selectable fields for applying an associated filter to the financial data; a Compare PY Return to CY Return sub-tab element for comparing the financial data in a current year tax return to financial data in a prior year tax return; and a Compare CY Provision to CY Return sub-tab element for allowing the user to compare the financial data in the current year tax return with the financial data in a selected tax income provision.

Yet further, when the View sub-tab element is actuated, the pane element displays a drop down menu that includes a plurality of selectable fields indicative of information related to the entity structure. The plurality of selectable fields can include one or more of an entity name field, entity type field, new entities field, terminated entities field, ownership field, and a functional currency field. The drop down menu can include a plurality of action buttons.

The method also provides for when the Deliverables Analysis tab element is actuated, the bottom pane element displays a plurality of sub-tab elements comprising a Potential Nexus Activity report tab element for displaying financial data associated with state apportionment activity, and a Changes to Filing Group report tab element for comparing and displaying information associated with one or more entities of a company of a current calendar year with similar data from a prior selected year. The method can further provide for, when the Acquisition Method Accounting tab element is actuated, displaying in the bottom pane element a plurality of sub-tab elements comprising a Temporary Difference sub-tab element for displaying information associated with an acquisition method accounting of the company, and an Impact on Permanent Differences sub-tab element for displaying information associated with transaction costs and book tax differences of the company.

The method further provides for, when the Equity Movement tab element is actuated, displaying in the bottom pane element a plurality of sub-tab elements comprising one or more of: a Summary of retained Earnings Activity sub-tab element for displaying financial data associated with retained earnings of the company; a Summary of Additional Paid in Capital Activity sub-tab element for displaying financial data related to capital of the company; a Summary of the Common Stock Activity sub-tab element for displaying financial data related to common stock of the company; a Summary of the Preferred Stock Activity sub-tab element for displaying financial data related to preferred stock of the company; and a Summary of Treasury Stock Activity sub-tab element for displaying financial data associated with activity involving treasury stock.

Similarly, the method can provide for, when the Step 2 View Accounts Analysis step icon element is actuated, displaying in the bottom pane element a second plurality of tab elements. The second plurality of tab elements can include one or more of: a New Accounts tab element for displaying when actuated selected portions of the financial data related to new general ledger accounts of the company; an Incomplete Mappings tab element for displaying when actuated one or more accounts where an analysis of the accounts has not yet been completed; a Deleted Accounts tab element for displaying when actuated the one or more accounts in a prior year tax return or provision that are absent from a current year tax return; a Change in Mappings tab element for displaying when actuated the one or more accounts of the company that has mapping changes; a Complete Mappings tab element for displaying when actuated one or more accounts of the company that have been mapped and displaying details associated with the mapping; and a Standard BTD Mapping tab element.

The present invention also provides for, when the Step 3 View Financial Statement Reconciliation step icon element is actuated, displaying in the bottom pane element a third plurality of tab elements that includes an Exchange Rate Workbook report tab element for displaying, when actuated, information associated with exchange rates being employed in a project employing the tax steps and used for translating financial data into one or more foreign currencies, an Adjusting Journal Entries report tab element for displaying one or more of the journal entries in the project, and a Financial Statement Reconciliation report tab element for displaying when actuated any differences between financial data entries in the workbook with selected financial data in the tax return.

Further, when the Step 4 View Federal Tax Income Activity step icon element is actuated, the bottom pane element displays a fourth plurality of tab elements that includes one or more of: a Diagnostics tab element for displaying, when actuated, the financial data employed to determine a taxable income, earnings and profit of the company and for allowing the user to review selected patterns in the financial data indicative of one or more errors; a Tax Adjustments Analysis tab element for displaying when actuated the financial data employed to determine a book tax difference of the company and to perform a risk based review of the book tax differences; a Basis Differences tab element for allowing when actuated the user to review and assess an accuracy of a basis difference in the financial data used in the tax return not affecting taxable income of the company; a Taxable Income Reconciliation tab element for displaying when actuated information associated with a reconciliation of the taxable income of the company in comparison to one or more previous income tax provisions; and a Checks and Balances tab element for displaying when actuated selected portions of the tax return of the company to ensure that certain aspects thereof are reconciled.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of the intelligent review and processing system of the present invention.

FIG. 2 is a user interface generated by the intelligent review and processing system of the present invention displaying on a display device the first step of the tax review process.

FIG. 3 is a user interface generated by the intelligent review and processing system of the present invention when the navigation pane is actuated,

FIGS. 4 and 5 are user interfaces generated by the intelligent review and processing system of the present invention that are associated with initiation of the first step of the tax review process.

FIGS. 6-14 are the user interfaces generated by the intelligent review and processing system of the present invention displaying the tab elements, sub-tab elements, and menu boxes associated with the first step of the tax review process.

FIG. 15 is a user interface generated by the intelligent review and processing system of the present invention associated with the initiation of the second step of the tax review process.

FIGS. 16-17 are the user interfaces generated by the intelligent review and processing system of the present invention displaying the tab elements, sub-tab elements, and menu boxes associated with the second step of the tax review process.

FIG. 18 is a user interface generated by the intelligent review and processing system of the present invention associated with the initiation of the third step of the tax review process.

FIG. 19 is an example of a user interface that is generated by the intelligent review and processing system of the present invention displaying the tab elements and sub-tab elements associated with the third step of the tax review process.

FIG. 20 is a user interface generated by the intelligent review and processing system of the present invention associated with the initiation of the fourth step of the tax review process.

FIGS. 21-23 are the user interfaces generated by the intelligent review and processing system of the present invention displaying the tab elements, sub-tab elements, and menu boxes associated with the fourth step of the tax review process.

FIG. 24 is a user interface generated by the intelligent review and processing system of the present invention associated with the initiation of the fifth step of the tax review process.

FIG. 25 is a user interface generated by the intelligent review and processing system of the present invention associated with the initiation of the sixth step of the tax review process.

FIG. 26 is a user interface generated by the intelligent review and processing system of the present invention associated with the initiation of the seventh step of the tax review process.

FIG. 27 is a schematic block diagram depicting an embodiment of a network environment comprising client devices in communication with servers through a network arrangement.

FIGS. 28 and 29 are schematic block diagrams depicting embodiments of computing or electronic devices useful for the methods and systems described herein.

### DETAILED DESCRIPTION

The present invention is thus directed to a system and method for processing, reporting, and displaying financial data. More particularly, the system and method of the present invention employs a user interface (UI) generator for generating a series of user interfaces or windows that display certain selected fields having actuatable tab elements, sub-tab elements and other associated soft buttons for processing and displaying financial data, as part of the tax return preparation process. The windows can be employed by a user of the system (e.g., a tax professional) in preparing one or more tax returns or filings. The windows can be structured and arranged so as to display relevant portions of the financial data that correspond to selected portions of the tax return, and to guide the tax professional through a structured series or sequence of steps when preparing the tax return. The system and method can also identify during the sequence of windows selected portions of the inputted financial data that may need to be further reviewed.

As used herein, the term “financial data” is intended to include any data that is associated with or contains financial or financial related information, such as tax information. The financial information can include information that is presented in free form or in a tabular format and is related to data associated with financial, pecuniary, monetary or tax interests. Further, the financial data can have a deliverables portion, where the deliverables are the listing of tax returns being prepared. The system of the present invention can analyze the completeness of the deliverables and consider any tax impacts of changes.

As used herein, the term “financial report” is intended to include any statement or report that exists in any suitable format (e.g., printed or in digital file format) that sets forth or includes financial data, including, for example, tax returns, income statements, cash flow statements, balance sheets, 10-K statements, 10-Q statements, audit reports, annual reports, loan applications, credit history reports, invoices, and the like.

As used herein, the term “tax return” or “tax filing” is intended to include any statement, report, document or form that exists in any format that is filed with a tax authority, such as a state or local tax authority or collection agency, or a national or country specific tax authority, such as for example the Internal Revenue Service (IRS) in the United States. The report can contain any specific arrangement and presentation of financial data that is used to calculate taxes, such as income tax or other taxes, or to collate or file tax related information. The tax returns are generally prepared using forms prescribed by the tax authority and can be prepared by a suitable tax professional.

As used herein, the term “entity” is intended to include a structure, facility, enterprise, business, company, operation, or organization, of any size. Further, the term is intended to include an individual or group of individuals, or a device of any type.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

The present invention is also related to a curated financial data and tax preparation review tool and system that guides the tax professional through a selected tax review process that includes a series of tax steps. The system and method of the present invention is configured such that relevant and pertinent financial data, including tax data, that is needed or required to perform a tax and risk-based review of the financial data of an entity, such as a company, is readily available to the tax professional for preparation of a financial report, such as for example a tax return. The system and method of the present invention can be used by tax professionals of all experience levels, since the structured nature of the system and method guides the tax professional through a selected sequence of the tax review and preparation process.

The system and method of the present invention also provides for diagnostics which search the financial data for certain aberrant data (e.g., red flags) that may indicate a potential error or issue and report the aberrant data to the user. Specifically, the system and method can employ smart diagnostics that analyze the data for selected patterns that the system can be trained to identify, as well as employs check and balances (e.g., confirming that the same number appears on varying schedules at various locations) when appropriate.

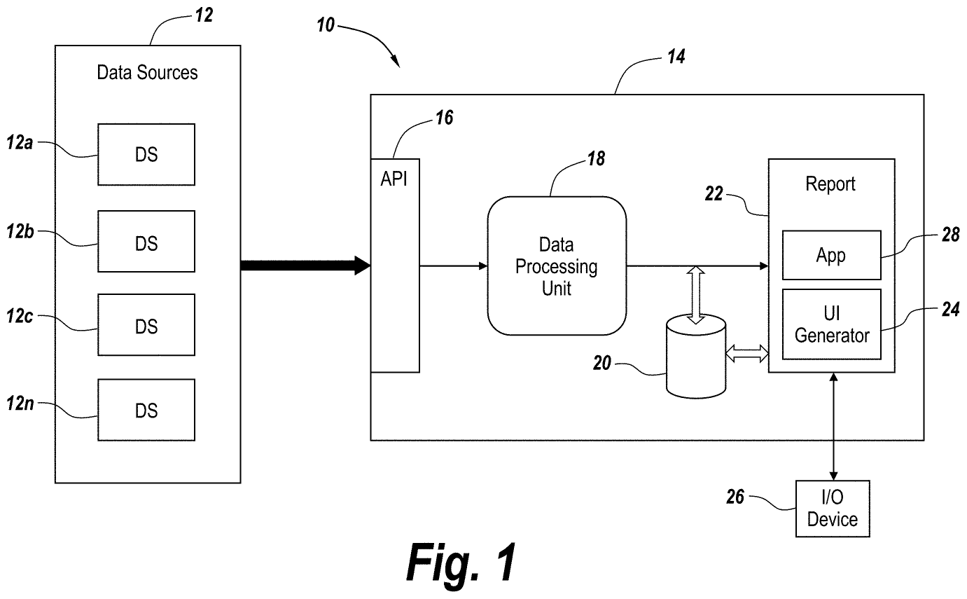

A simplified schematic representation of the intelligent review and processing system 10 of the present invention is illustrated in FIG. 1. Those of ordinary skill in the art will readily recognize that other system components and software applications, and associated functionalities, can also be associated with or implemented by the intelligent review and processing system 10. These additional elements and features are omitted for the sake of clarity. The illustrated system 10 can include a data source 12 that schematically represents a plurality of data sources 12a-12n. The data sources 12a-12n can provide to the system many different types of data, including for example financial data. The data sources 12 can represent data that is provided from other parts of the system, from remote parts of the system, as well as financial data that is provided to the system from one or more entities, such as a client or company. One example of the type of data source that provides financial data from a client enterprise system includes enterprise resource planning systems (ERPs). The financial data can be provided to the intelligent review and processing system 10 in any selected format, such as for example in Excel spreadsheet format, and can include Excel workbooks. Further, the financial data can include ledger data (e.g., trial balance data) that can be imported into a system using a template. Other items with associated financial data being manipulated can be done in the system. The financial data can include data associated with one or more federal workbooks or workpapers, state workbooks or workpapers, supplemental financial data for tax purposes, and international workbooks or workpapers and associated financial data, as well as financial data associated with the company. As is known in the art, workbooks or workpapers provide a convenient location for entry of financial data as well as implementing updates to any associated logic used in the data calculations. The workbooks can have any selected format, and are preferably standardized. As such, the workbooks oftentimes are the substantiation to support the tax return.

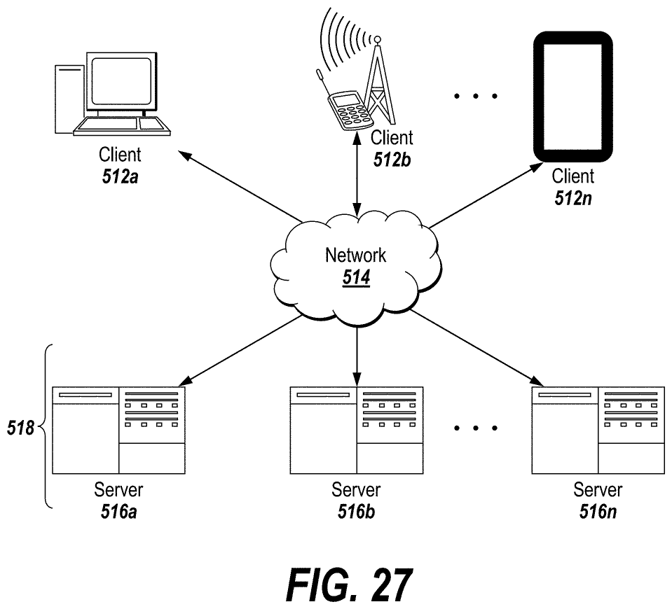

The financial data from the data sources 12a-12n can be conveyed or transferred to the remainder of the system 10, illustrated in a highly simplified manner as electronic device or system 14. The data sources 12 can communicate with the electronic device 14 through a wired or wireless connection, as well as through a suitable network. Those of ordinary skill in the art will readily recognize that the data sources and electronic device 14 can include a one or more electronic devices, such as clients, servers, computing devices and the like, that are networked together and which implement the functionality of the present invention, FIGS. 27-29. The electronic device 14 can include if desired an application programming interface (API) for communicating with various other software applications associated with the system and with the data sources 12a-12n. The financial data is then conveyed to a data processing unit 18 for processing the financial data according to the needs of the system 10. The data processing unit 18 represents the data processing capabilities of the overall system, and can be distributed across the system 10, as is known in the art. The data processing unit 18 can thus include one or more processors. The data processing unit 18 can communicate with a system storage element and/or memory 20 for storing processed data and the like. The storage element 20 represents in a highly simplified manner the overall storage capabilities of the system, and can also be distributed across the system 10, as is known in the art. The storage element 20 is represented for the sake of simplicity as a database, but can be any selected known type of storage or memory element. The data processing unit 18 and the storage element 20 can communicated with a report generator 22. The report generator 22 can generate any selected type of financial report for formatting and displaying the financial data. According to one practice, the report generator 22 can include any suitable software application 28, such as a tax return generation software application, that performs the functions associated with the tax return generation feature of the present invention. The report generator 22 can also include a user interface (UI) generator 24 for generating in connection with the application software 28 one or more user interfaces for display on a suitable display device. The interfaces can display selected portions of the financial data when processed according to the requirements of the software application 28. Further, the report generator 24 can communicate with one or more input-output (I/O) devices 26, which can include a display, a selection device such as a computer mouse, a keyboard, and the like, according to known techniques. The report generator and/or the user interface generator can form part of the electronic device or can be separate therefrom.

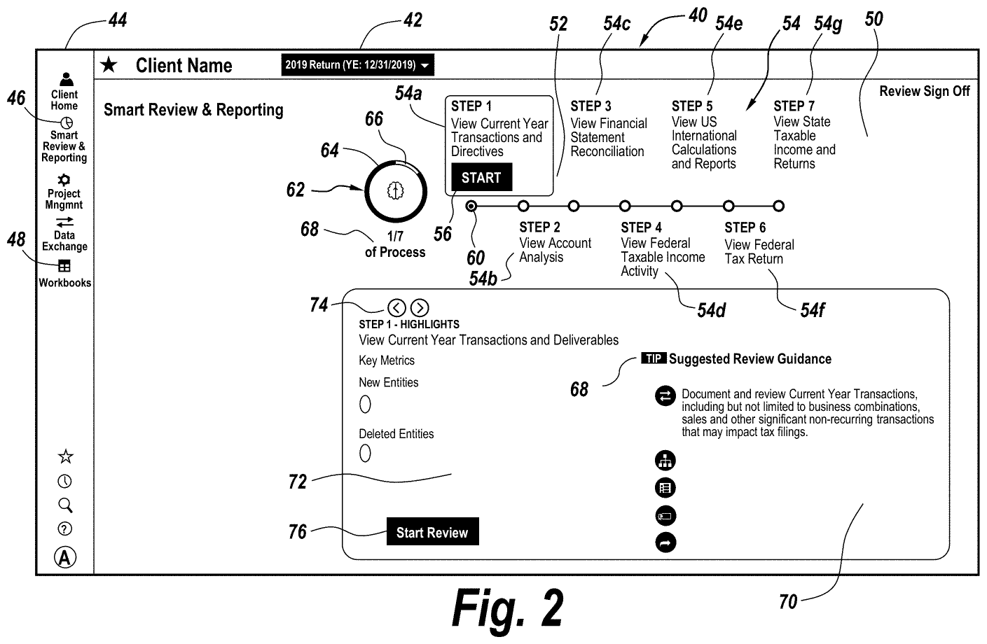

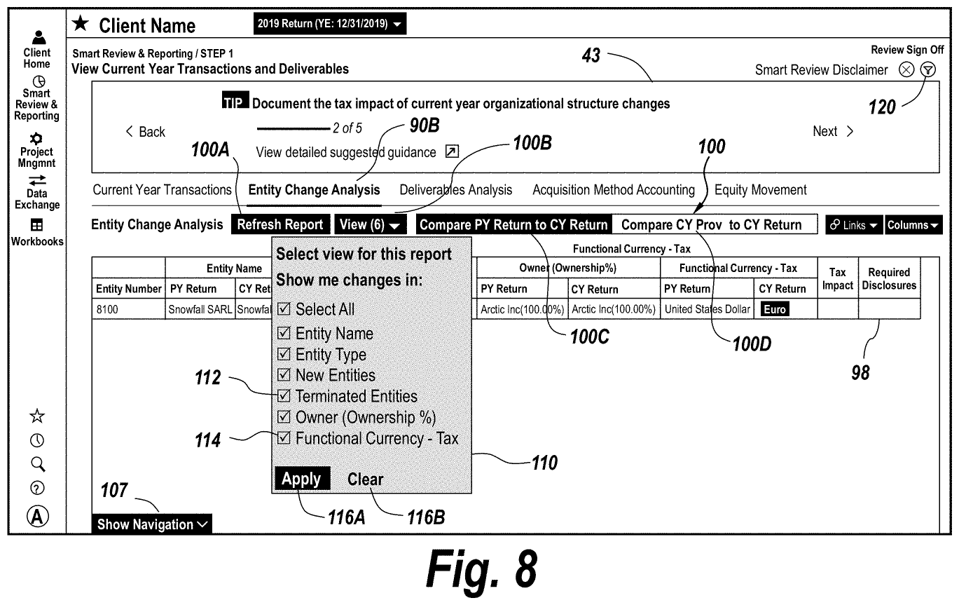

The UI generator 24 can generate a series or sequence of interfaces that can be displayed on the display device. The user interfaces can display to the user in an organized manner the financial data that is processed according to the requirements of the tax return generation software. Suitable examples of the user interfaces are shown in FIGS. 2-26. The user interfaces display or show a sequence or series of interfaces that allow the tax professional to review the financial data from the data sources 12a-12n and to review and process tax related information from the financial data during the preparation and review of a tax return. The tax return relies oftentimes on a series of related and accompanying reports and workbooks, and the system of the present invention ensures that this information is readily available to the user. Further, the intelligent review and processing system 10 is intended for use by users of all levels, and the users of the system can be employees of the company, external or third party tax professionals, or a combination of both.

The financial data that is processed by the electronic device 14 in accordance with the tax review software can display via the user interfaces selected portions of the financial data of a selected company, including for example, company specific information, financial transactions, deliverables information, state apportionment information (e.g., sales information, property information, payroll information), entity structure information, geographic location information, exchange rate information, workbook information including both state and federal, tax basis information, tax law information, goodwill information, transaction cost information, earnings information, capital information, stock information, financial statement and balance and income sheet information, accounting information, taxable income information, prior tax return information, and the like.

The system and method of the present invention provides a curated and guided process and method that guides a user, such as for example a tax professional, through a series of steps or sections, including a Current Year Transactions and Deliverables step, an Accounts Analysis step, a Financial Statement Reconciliation step, a Federal Tax income Activity step, a US International Calculations and Reports step, a Federal Tax Return step, and a State Taxable Income and Returns step. The steps can be followed in sequence, or the user can navigate between the various steps, in any order, as the need arises. The various steps can be accessed through different aspects or features on the user interface, so as to provide maximum flexibility to the system user. Further, the report generator can be configured to generate and then display in the window of the user interfaces suggested tips or hints as the user navigates through the various user interfaces.

As shown in FIG. 2, the user interface unit 24 can generate for display on the display element 26 a selected user interface or window element 40 (herein generally referred to as a window, a frame or a page). The graphical user interface is a series or system of interactive visual components that can be executed by suitable software, such as the software application 28. The user interface can hence include windows, pane elements, tab elements, sub-tab elements, ribbons, bars, soft buttons, icons, objects, menus, and graphical elements that convey information, execute commands, and represent actions that can be taken by the user. The objects or icons can remain static or can change or vary when the user interacts with them. Hence, the system 10 includes suitable application software 28 that is executed to produce or generate the user interfaces of the present invention. The software application can be stored for example in the user interface generator unit 24 for generating one or more of the user interfaces.

The illustrated window element 40 of the present invention can include a header pane or ribbon 42 that is disposed or located at the topmost portion of the window element 40. The header pane can change based on the specific user interface that is generated or can be persistent and thus always present in the window 40. The information in the header pane can also change if desired. The window element 40 can also include along the left hand side of the window element 40 a persistent navigation pane 44 that extends from a top portion of the window element to a bottom portion of the window element. The navigation pane 44 can be configured to display selected information or to include one or more soft or actuatable buttons, such as for example a soft button or key 46, labeled Smart Review and Reporting, that initiates the generation of one or more of the user interfaces. More specifically, the actuation of the soft button 46 by for example by a computer mouse by a user launches the software application 28 that generates, via the user interface generator 24, the user interfaces of the present invention. The navigation pane 44 can also include an actuatable soft button 48 that is labeled Workbooks, which allows the user access to one or more workbooks that form part of the financial data used in the tax preparation process.

The window element 40 can include beneath and adjacent to the header ribbon 42 an upper or top pane element 50 and can include a lower or bottom pane element 70, that is disposed below the top pane element. The illustrated top pane element 50 can include a graphical element 52 that is preferably representative of the series of steps that the user can be guided through by the system of the present invention. The graphical element 52 can be configured, for example, as a timeline with waypoints that has a series of step icons 54 associated therewith. Each of the step icons 54a-54g are actuatable and can correspond to one of the steps in the tax preparation process. For example, the step icon 54a can be labeled as Step 1—View Current Year Transactions, which corresponds to the current year transactions and deliverables for a selected client. The step icon 54a can also include if desired a start button 56 for starting or launching execution of the underlying software application 28. Further, the timeline waypoint associated with the step icon 54a can be highlighted by a highlight icon 60 when the step icon 54 is selected by the user.

The illustrated graphical element 52 also includes step icon 54b that can be labeled as Step 2—View Accounts Analysis, and which can correspond to the financials of the client that drives taxable income and the general presentation of the tax return. The graphical element 52 also includes step icon 54c that is labeled Step 3—View Financial Statement Reconciliation. This step can correspond to the system and user analyzing the completeness, appropriateness and accuracy of the journal entries in the return, as well as allowing the user to compare financial details in the workbook (e.g., federal workbook) with the values set forth in any corresponding financial report. The timeline can also include step icon 54d labeled Step 4—View Federal Tax Income Activity that allows the user to view and assess the taxable income, earnings, and profits of the client. The graphical element also includes step icon 54e labeled Step 5—View US International Calculations and Reports, which allows the user to view via suitable links any necessary workbook and U.S. and international financial reports. The graphical element also includes step icon 54f labeled Step 6—View Federal Tax Return that allows the user to review the completed tax return, and step icon 54g labeled Step 7—View State Taxable Income and Returns, which provides links to state related financial information. The foregoing Steps 1-7 form the tax review steps that constitute the tax review process of the present invention.

The pane element 50 can also include a second graphical element 62 that displays via a circular representation and associated counter the specific step in the process. For example, as shown, the graphical element 62 includes a circle element 64 that has a highlighted portion 66 that corresponds to the particular step in the process. The graphical element also includes a counter element 68 that displays the step number relative to the total number of steps in the process (e.g., 1/7).

The lower pane element 70 or the window element 40 can display certain selected information associated with the steps in the process. For example, the pane element can display tip information 68. The lower pane element can also display tab elements, sub-tab elements, menus, navigation icons 74, and information 72 associated with each respective step and tab element of the process. The navigation icons allow the user an optional method of moving or navigating through the steps of the tax review sequence or process. The pane element 70 can also include an actuatable Start Review navigation button 76 that when actuated by the user starts the tax preparation and review process (e.g., Smart Review) of the present invention.

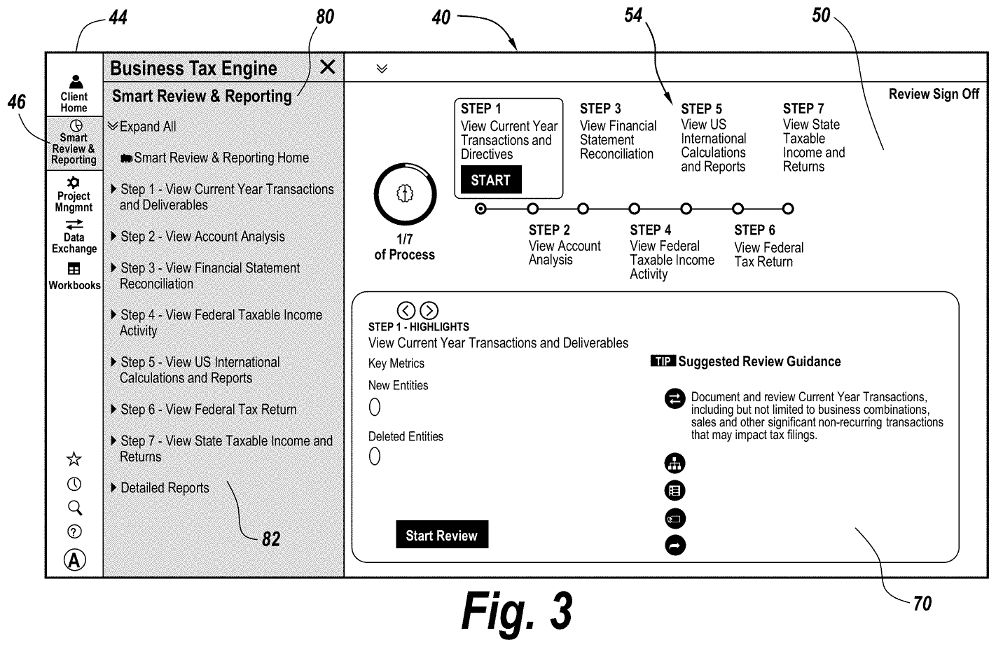

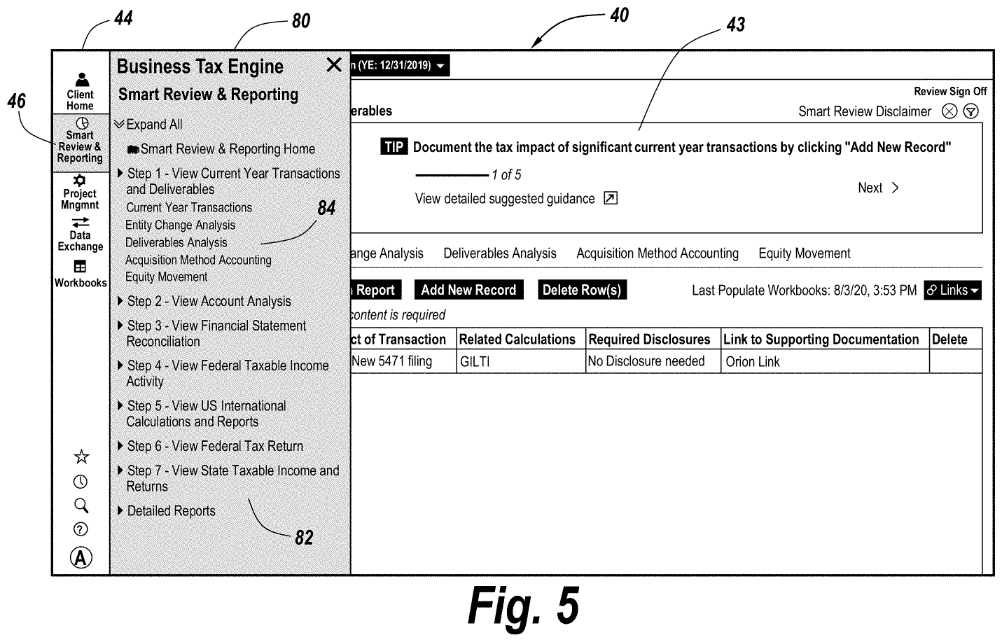

FIGS. 3 and 5 show the window element 40 when the Smart Review soft button key 46 in the navigation pane 44 is actuated by the user. When actuated, the window element 40, in addition to the pane elements 50, 70, displays a menu pane 80. The menu pane 80 can display selected information, such as for example a list of the Steps 82 set forth in the pane element 50. According to one practice, each of the illustrated Steps in the menu pane 80 can include a sub-menu of steps 84 that can, according to one practice, correspond to tab elements or sub-tab elements set forth in one or more of the pane elements of the window element 40. The steps listed or set forth in the menu pane 80 as well as the sub-menus 84 are actuatable by the user and can allow the user to navigate to the window element or interface that displays information associated with the selected step.

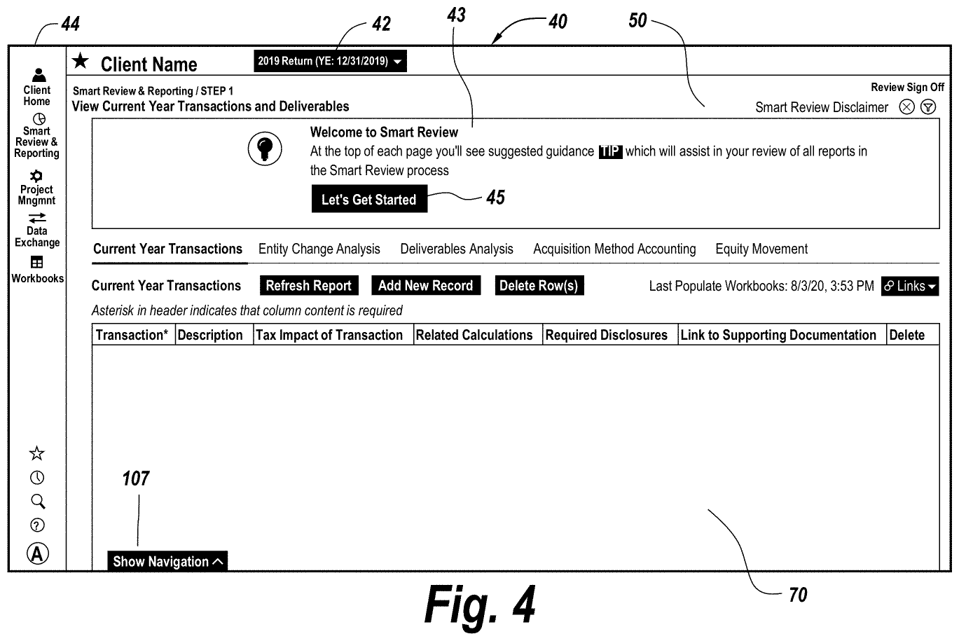

When the tax review process of the present invention is initially launched, the user interface generator 24 can generate for display on a display device a window element 40 having the pane element 50 that displays information, such as for example in an optional dialogue box 43, as shown in FIG. 4. The dialogue box can display welcome information to the system user, and can also include an actuatable button element 45 for launching via the software application 28 the tax preparation and review process.

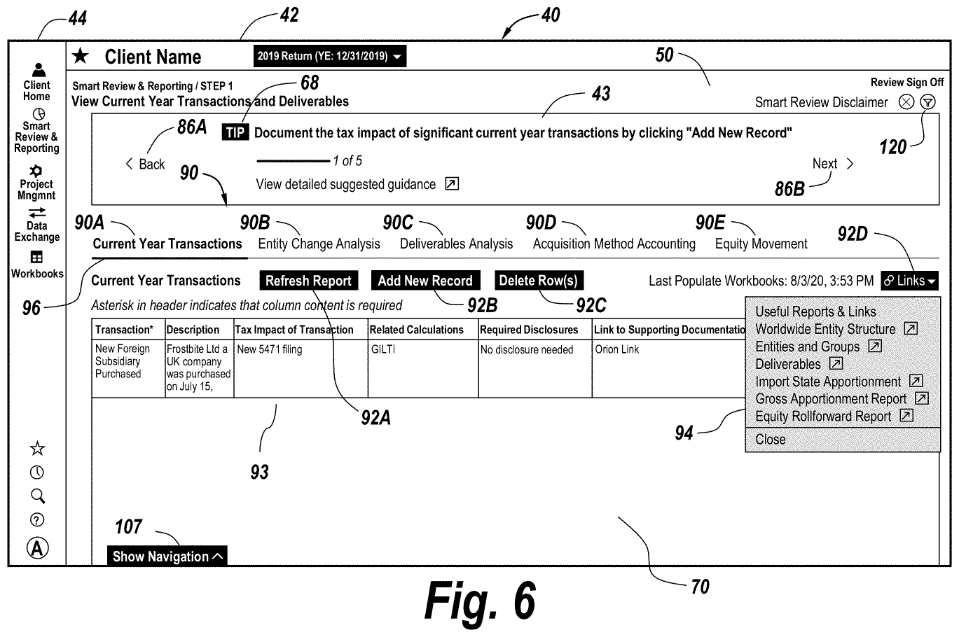

FIGS. 4-14 illustrate the interfaces that are generated by the user interface generator 24 and displayed on a display when the Step 1—Current Transactions and Deliverables menu, step icon 54a button, or associated Start button 56 is actuated. The window element 40 includes the persistent header pane 42 and the persistent navigation menu 44. The top or upper pane element 50 can also include if desired the dialogue box 43 that displays information or data associated with Step 1. As shown for example in FIG. 6, the pane element 50 can include a description of the purpose of the Step in the current tax preparation and review process, as well as provide tips 68 to the user and other associated information. As used herein, the term “tips,” “tip” or “tip information” is intended to mean or include any information that is related to the financial data associated with the selected step in the tax preparation and review process, and which is helpful and useful to the user when reviewing the displayed data. Further, the tip information can provide guidance with optional suggestions about what a user can do with the associated report or indicate or display to the user additional information about what the report is showing or displaying. The pane element 50 can also include additional actuatable navigation icons, such as the back navigation arrow or icon element 86A for sorting or navigating through the steps in the tax review process in a descending order and a forward navigation arrow or icon element 86B for sorting or navigating through the steps in the tax review process in an ascending order. The navigation icons thus allow the user to navigate backwards or forward in the tax review process.

The lower pane element 70 can then display or include a plurality of actuatable tab elements 90 related to the specific step in the process. For example, the tab elements 90 can include a Current Year Transactions tab element 90A that allows the user the ability to document and review current year transactions, such as business combinations, dispositions and other significant non-recurring transactions that may or can impact the tax return of the company; an Entity Change Analysis tab element 90B that allows the user to review changes to the overall entity structure of the company; a Deliverables Analysis tab element 90C that allows the user to review the completeness and accuracy of the deliverables set forth therein and to determine the potential tax impacts or required disclosures; an Acquisition Method Accounting tab element 90D that allows the user to review the tax impact of acquisitions including determinations of tax basis, treatment of transaction costs and the impact on basis differences; and an Equity Movement tab element 90E that allows the user to review and consider the tax consequences for disclosures and elections needed for equity activity. The tab elements 90 can be actuated by the user and different selected information can be displayed in the lower pane element 70, as well as in the upper pane element 50.

The lower pane element can also display information associated with the selected tab element. For example, as shown in FIG. 6, when the Current Year Transactions tab element 90A is selected, the pane element 70 can display information 93 associated with selected transactions that occurred during the calendar year. The lower pane element 70 can also selectively include one or more actuatable soft buttons or sub-tab elements indicative of different functions. For example, the pane element 70 can include a sub-tab element 92A for refreshing reports linked to the current interface and step, sub-tab elements 92B and 92C for adding or deleting a report, and sub-tab element 92D for accessing if available additional information that is linked to the current tab element and in turn the current process step. By way of example, and with continued reference to FIG. 6, the user can actuate the link soft button 92D, and the user interface generator 24 and the software application 28 can generate in the pane element 70 a submenu 94 that lists one or more links that are available to the user. Further, a highlight graphical element 96 can be employed in connection with one or more of the tab elements 90 to highlight the specific tab element that was either actuated by the user is associated with the information displayed in the pane elements 50, 70.

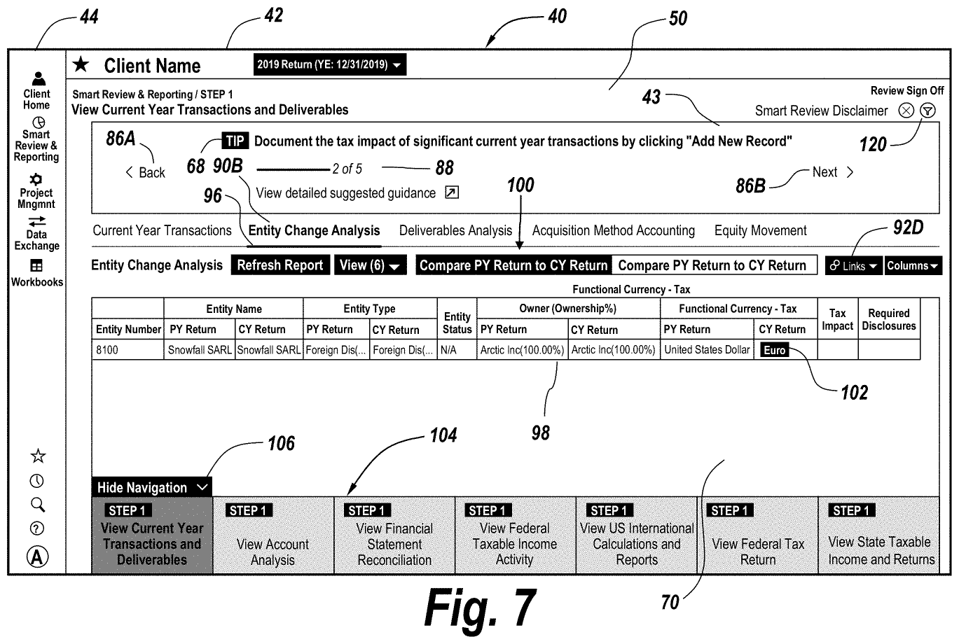

FIG. 7 illustrates the window element 40 when the Entity Change Analysis tab element 90B is actuated by the user. When actuated, the tab element 90B is highlighted by the highlight graphical element 96. The pane elements 50 and 70 can display information associated with tab element 90B. For example, the pane element 50 can display selected tip information 68 associated with the tab elements and sub-tab elements, as well as the navigation buttons, and the pane element 70 can set forth information 98 specific to and associated with the particulars of the entity (e.g., client). By way of example, the pane element 70 can display selected actuatable soft buttons or sub-tab elements 100 that provide the user the ability to perform other functions or access other types of information. The system 10 of the present invention also processes and analyzes the information 98 displayed in the pane element 70 to determine whether certain parts of the information warrant further review by the user. That is, the information 98 displayed in the pane element 70 may be incorrect, may be different than what the system expected, or may warrant further review. If this occurs, the system can highlight the aberrant data so as to visually distinguish the data so as bring the data to the attention of the user. As shown in the pane element 70, the information in the Functional Currency column is highlighted 102 so as to prompt further review by the user. The highlight feature 102 can be any selected type of feature that visually distinguishes the data from surrounding data or from the surrounding background. One example of a suitable highlight feature is to distinguish the data by color. Further, the pane element 50 can include a counter graphical element 88 that sets forth the total number of tab elements associated with the selected Step, as well as the number associated with the actuated or selected tab element (e.g., 2 of 5).

The illustrated window 40 can also include at a bottom portion thereof a second navigation pane, bar or ribbon, such as the navigation bar 104. The navigation bar 104 can display a series of navigation options that are similar to the navigation options (e.g., step icons 54) shown in FIGS. 2-3. The user can select the Step that they wish to access and the user interface generator 24 can update the window 40 to display information associated with that specific step in the tax review and return generation process. The navigation bar 104 can be persistent or the user can hide the navigation bar, such as by selecting a Hide Navigation soft button that is associated with the bar 104 when selected by the user. For example, as shown in the navigation bar 104, the Step 1 step icon is selected and highlighted, and a Hide Navigation soft button 106 is associated therewith. The Hide Navigation soft button 106 can be actuated by the user, and when actuated, the navigation bar 104 can disappear. When the navigation bar disappears, the pane element 70 can display an actuatable soft button 107 labeled Show Navigation that allows the user to display once again the navigation bar 104 by actuating the button 107.

Further, as shown in FIGS. 7-9, the actuatable soft buttons or sub-tab elements 100 can include a Refresh Report sub-tab element 100A that allows the user to refresh a displayed report, and a sub-tab element 100B directed to a view filter that allows the user to view prior changes in selected fields as well as in selected reports. When the View sub-tab element 100B is actuated, the pane element 70 displays a drop down menu 110 that provides a list 112 of locations or fields in the entity change information that are selectable by the user by one or more selection elements 114. In the illustrated example, the list can include an entity name field, entity type field, new entities field, terminated entities field, ownership field, and a functional currency field. The list can also include one or more action buttons, such as an Apply button 116A which when actuated applies a selected change to a selected field based on the user selections and a Clear button 116B which when actuated clears a change from a selected field. The actuatable sub-tab elements 100 also include a sub-tab element 100C labeled Compare PY Return to CY Return that compares the current year tax return with a selected prior year tax return, and a soft button 100D labeled Compare CY Provision to CY Return that allows the user to compare the current year tax return with a selected current year provision.

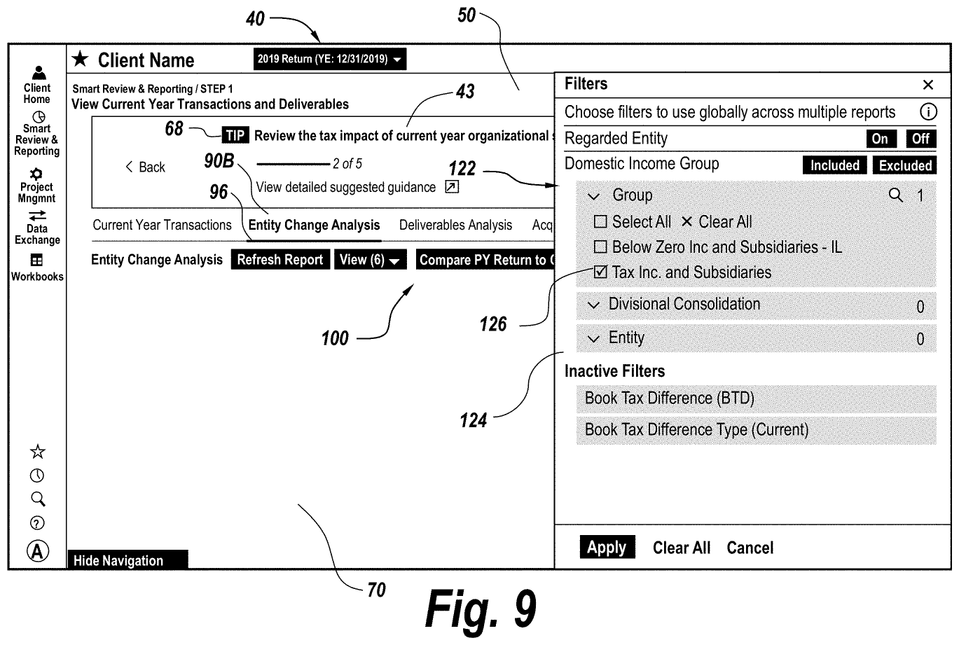

The upper pane element 50 can also include an actuatable filter element or button 120 that allows the user to select one or more data filters from a list of data filters. Specifically, as shown in FIG. 9, when the filter element 120 is actuated by the user, the window element 40 displays along a right side thereof a filter list 122 that sets forth or lists one or more data filters 124 that can be selected by the user by one or more selection elements 126 and applied to the financial data that is processed by the system in the selected step. The filters set forth in the filter list can change or vary based on the specific Step, tab element, and sub-tab elements that are selected by the user.

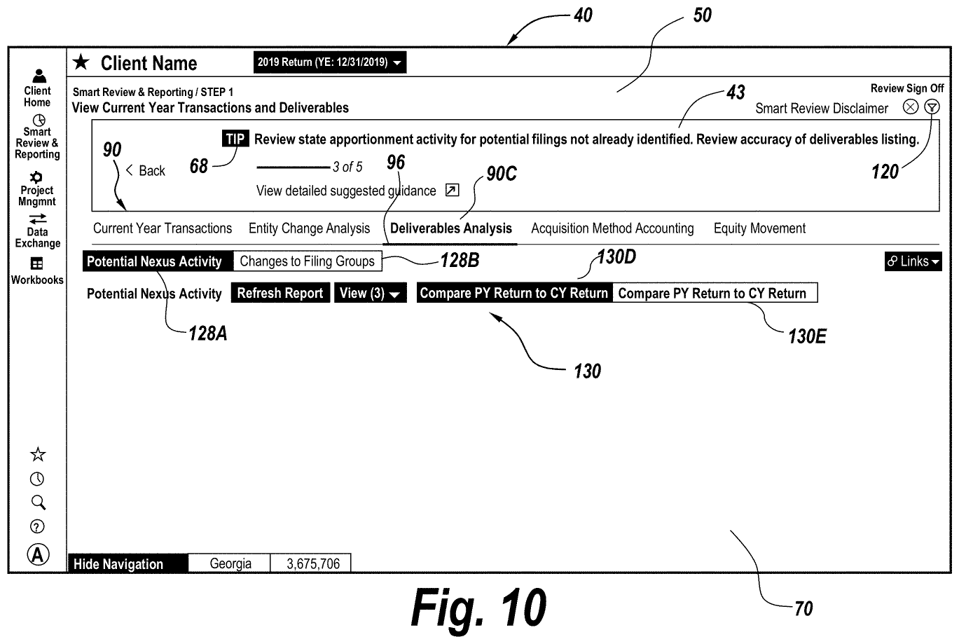

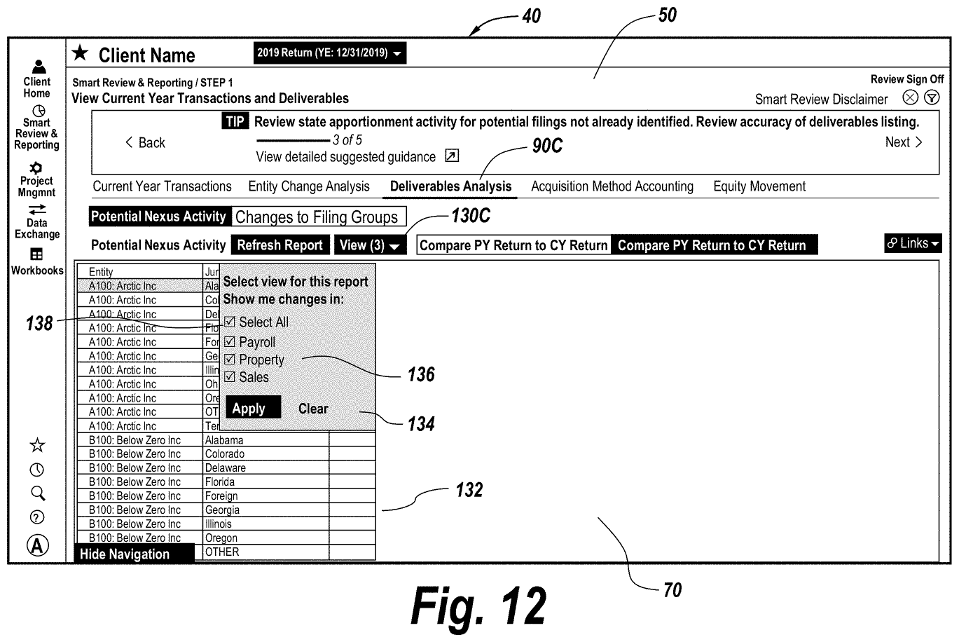

FIGS. 10-12 show the window element 40 when the Deliverables Analysis tab element 90C is actuated by the user. When actuated, the tab element 90C is highlighted by the highlight graphical element 96. The pane elements 50 and 70 can display information associated with the tab element 90C. For example, the pane element 50 can show a tip 68 associated with the tab element 90C and can display associated tip information. The pane element 70 can set forth information 132 specific to and associated with the tab element 90C, and can include for example information associated with the deliverables of the client. Further, the pane element 70 can display selected actuatable report tab elements, such as the Potential Nexus Activity report tab element 128A and the Changes to Filing Group report tab element 128B. The report tab element 128A when actuated can display information associated with state apportionment activity and the report tab element 128B when actuated can compare and display information associated with one or more entities or groups of the company of a current calendar year with similar data from a prior selected year. Each of the report tab elements 128A, 128B can optionally have associated therewith selected soft buttons that provide the user the ability to perform other functions or access other types of information. For example, the Potential Nexus Activity report tab element 128A can have associated therewith the soft buttons 130. The soft buttons 130 can optionally include for example a Potential Nexus Activity soft button 130A that instructs the system to process information, such as financial data, and then display on the display device information associated with the state apportion activity that allows the user and hence the system to analyze for potential tax filings that have not already been identified. Further, when the Potential Nexus Activity button 130A is actuated, the system compares changes in sales, property and payroll data that can be further divided or partitioned by entity and jurisdiction. In this regard, the intelligent review and processing system 10 of the present invention can import financial data associated with a prior project and a current year project. The Refresh Report soft button 130B actuates or instructs the system 10 to refresh the data in one or more reports, such as the displayed report. The View soft button 130C allows the user to access and display one or more reports associated with the Potential Nexus Activity tab element 128A. For example, as shown in FIG. 12, the View soft button 130C can be actuated such that the window 40 and specifically the pane element 70 can display a menu box 134. The menu box 134 can include a listing of the reports 136 that are accessible by the user. The reports 136 can include payroll reports, sales reports, and property reports. The reports 136 can be selected by the user via a selection mechanism (e.g., a computer mouse) using selection boxes 138 associated with each report in the report list, The soft buttons further include a pair of compare soft buttons, including a Compare PY Return to CY Return button 130D that allows the user to compare returns from different years, and a Compare CY Provision to CY Return button 130E for allowing the user to compare selected financial in a selected portion or provision of the tax return to prior provisions.

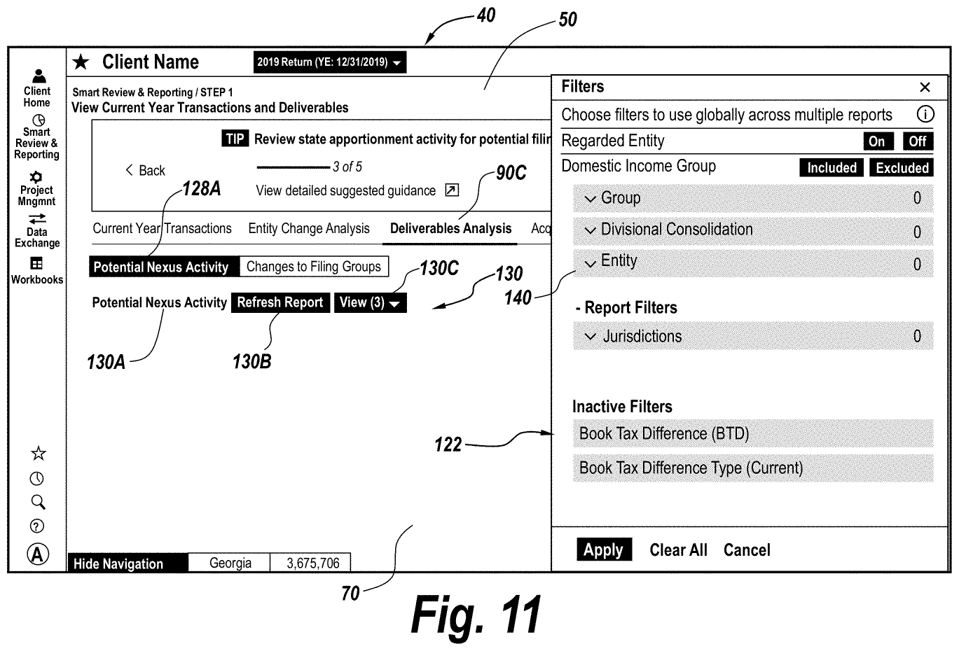

As shown in FIG. 11, the actuatable filter button 120 allows the user to select one or filters from a list of data filters. Specifically, when the filter element is actuated by the user, the window element 40 displays along a right side of the window a filter list 122 that sets forth or lists one or more filters 140 that are related to the actuated tab element 90C. As illustrated, the filter list 122 can include filters such as Group, Divisional Consolidation, Entity, and Jurisdiction.

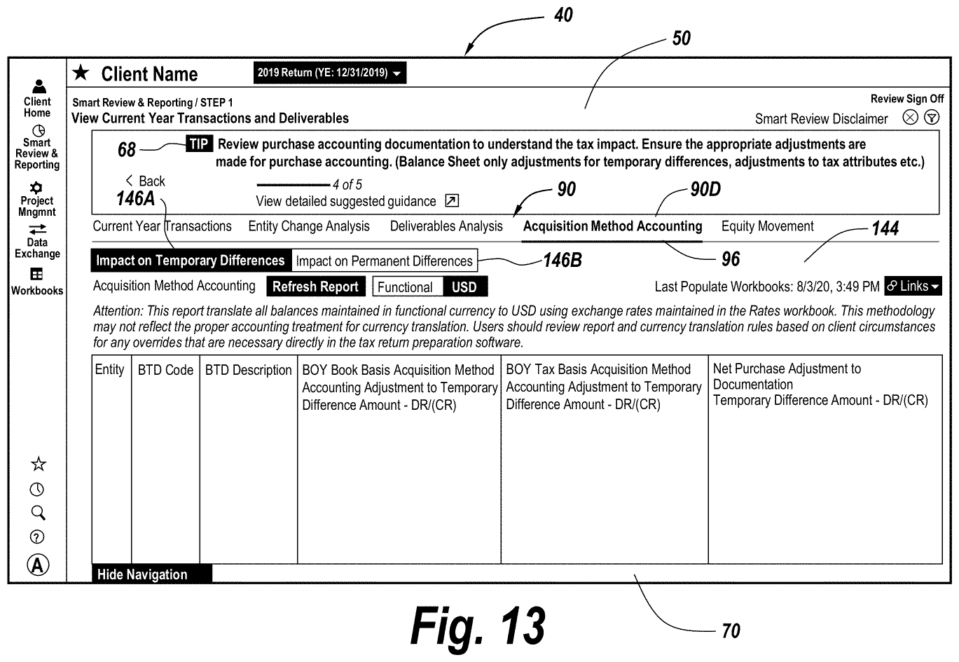

FIG. 13 show the window element 40 when the Acquisition Method Accounting tab element 90D is actuated by the user. When actuated, the tab element 90D is highlighted by the highlight graphical element 96. The pane elements 50 and 70 can display information associated with the tab element 90D. For example, the pane element 50 can show a tip 68 associated with the tab element 90D. The pane element 70 can set forth information 144 specific to and associated with the tab element 90D, and can include for example information associated with the tax impact of acquisitions including the determination of tax basis, treatment of transactions costs and any impact on basis differences. Further, the pane element 70 can display selected actuatable report tab elements, such as the Impact on Temporary Difference report tab element 146A and the Impact on Permanent Differences report tab element 146B. The report tab element 146A when actuated by the user can display information associated with the impact on temporary tax differences, such as current goodwill, that can be set forth in one or more workbooks, such as the federal workbook. The report tab element 146B when actuated can display information associated with transaction costs and book tax differences. Each of the report tab elements 146A, 146B can optionally have associated therewith selected soft buttons that provide the user the ability to perform other functions or access other types of information or financial data.

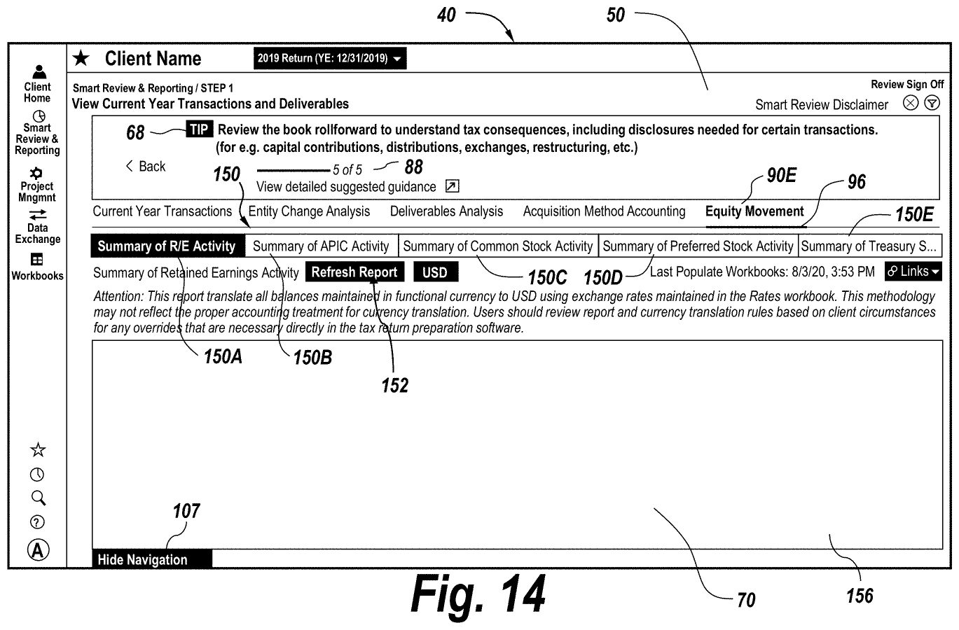

FIG. 14 shows the window element 40 when the Equity Movement tab element 90E is actuated by the user. When actuated, the tab element 90E is highlighted by the highlight graphical element 96. The pane elements 50 and 70 can display information associated with the tab element 90E. For example, the pane element 50 can show a tip 68 having tip information associated with the tab element 90E. The pane element 70 can set forth information 156 specific to and associated with the tab element 90E, and can include for example information associated with the equity activity of the company. Further, the pane element 70 can display selected actuatable sub-tab elements 150, such as the Summary of Retained Earnings Activity sub-tab element 150A, the Summary of Additional Paid in Capital Activity sub-tab element 150B, the Summary of the Common Stock Activity sub-tab element 150C, the Summary of the Preferred Stock Activity sub-tab element 150D, and the Summary of Treasury Stock Activity sub-tab element 150E. The Summary of Retained Earnings Activity sub-tab element 150A when actuated by the user displays information in the pane element 70 related to any financial data or information associated with the retained earnings of the company. The Summary of Additional Paid in Capital Activity sub-tab element 150B when actuated can display in the pane element 70 financial data that is related to any additionally paid company capital. The Summary of the Common Stock Activity sub-tab element 150C and the Summary of the Preferred Stock Activity sub-tab element 150D when actuated can display in the pane element 70 any selected information or financial data associated with the common or preferred stock of the company. The Summary of Treasury Stock Activity sub-tab element 150E when actuated by the user can display in the pane element 70 any selected information associated with activity involving treasury stock. The pane element 50 can display any preselected tip 68 associated with any of the foregoing tab elements and sub-tab elements. The illustrated sub-tab elements 150 can also optionally have one or more report soft buttons associated therewith. For example, as shown, the Summary of retained Earnings Activity sub-tab element 150A can have the report soft buttons 152 associated therewith.

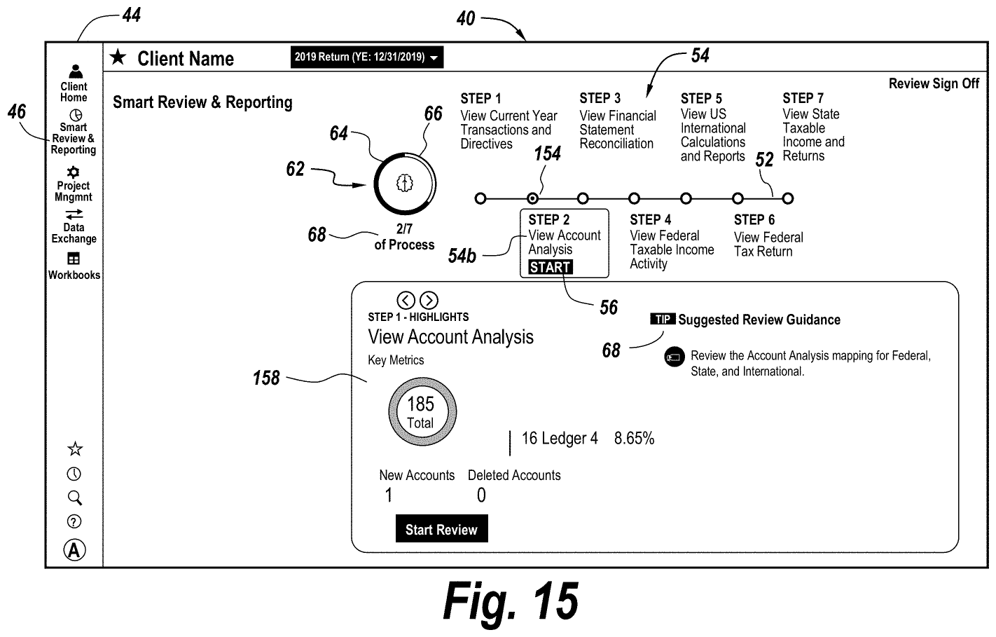

The intelligent review and processing system 10 of the present invention can allow the user through a selection device to advance the tax review process of the present invention to Step 2 of the tax review steps either through use of the navigation pane 44 and the associated menu pane 80, through actuation of one or more of the step icons 54, or through use of the navigation arrows 86A, 86B. As shown in FIG. 15, the system 10 allows the user to select Step 2—View Accounts Analysis by actuating for example the start button 56 on the Step 2 step icon element 54b. Further, the timeline waypoint graphical element 52 associated with the step icon 54b can be highlighted by a highlight icon 154 when the step icon is selected by the user. The window 40 can also include a second graphical element 62 that displays via a circular representation and associated counter the specific step in the process. For example, as shown, the graphical element 62 includes the circle element 64 that has a highlighted portion 66 that corresponds to the particular step in the process. The relative size of the highlighted portion can change and cover lesser or greater portions of the circumference of the circular graphical element 62 as a function of the specific step of the process. The graphical element 62 also includes the counter element 68 that can be updated to display the step number relative to the total number of steps in the process (e.g., 2/7). The second step in the review process implemented by the intelligent review and processing system 10 of the present invention ensures the accuracy of the accounts of the company. The window 40 can simultaneously display general information 158 associated with Step 2. The information 158 can also be associated with an analysis of the accounts of the company.

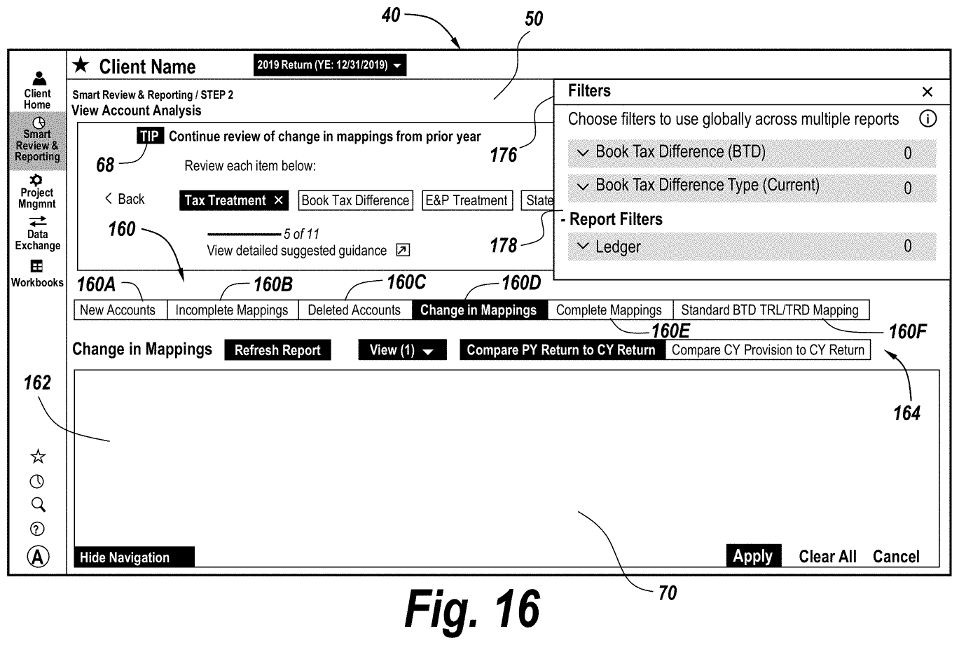

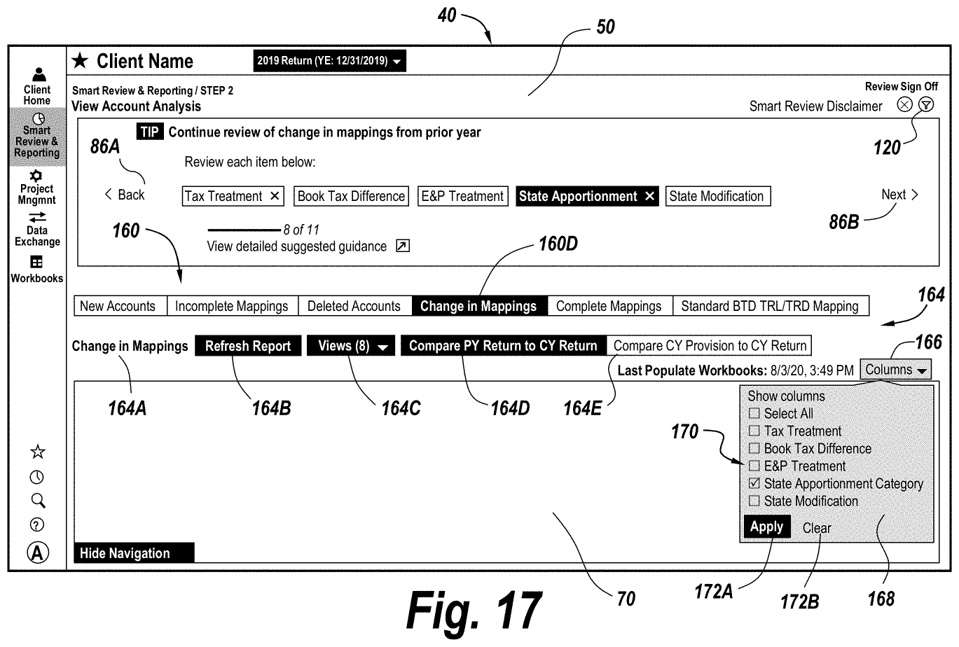

FIGS. 16 and 17 illustrate the information and associated actuatable tab elements, sub-tab elements and buttons that are displayed in the window 40 and the associated pane elements 50, 70 when Step 2 of the review process is selected and actuated. As shown, when for example the Step 2 icon 54b is actuated, the pane element 50 can display tip information 68 associated with the step for use by the user and the pane element 70 can display a series of tab elements 160, sub-tab elements 164 and any associated or related information 162. The tab elements 160 include a New Accounts tab element 160A, an Incomplete Mappings tab element 160B, a Deleted Accounts tab element 160C, a Change in Mappings tab element 160D, a Complete Mappings tab element 160E, and a Standard BTD Mapping tab element 160F. The New Accounts tab element 160A displays in the pane element 70 company accounts that did not exist in the prior year tax return or the current year provision project. The Incomplete Mappings tab element 160B can display in the pane element 70 the company accounts that have not been fully mapped to a standard account analysis that can form part of a workbook, such as the federal workbook. The Deleted Accounts tab element 160C can display in the pane element 70 the company accounts that existed in the prior year tax return or the current year provisions project but does not exist in the current year tax return. The Change in Mappings tab element 160D can be actuated by the user and can display in the pane element 70 any company account that has mapping changes. For example, the UI generator 24 of the system 10 can compare each column in the current year Account Analysis tab in the federal workbook to the prior year return or to the current year provision. The system can highlight any changes to the mappings. The Complete Mappings tab element 160E can display in the pane element 70 that accounts that are fully mapped to the federal workbook.

The illustrated tab elements 160 when actuated can also optionally have associated therewith one or more sub-tab elements. For example, the Change in Mappings tab element 160D can have the sub-tab elements 164 associated therewith. The sub-tab elements 164 can include a Change in Mappings sub-tab element 164A that allows the user to see changes in mappings associated with the tab element 160D; a Refresh Report sub-tab element 164B that allows the user when actuated to refresh the information in a displayed report; a View sub-tab element 164C that allows the user to view reports related to the displayed information, and which can be similar to the View soft button 130C and when actuated can also display a menu box and list of reports; a Compare Prior Year return sub-tab element 164D that allows the user when actuated to compare the current tax return being prepared to a previous or prior year tax return; and a Compare Current Year Provision sub-tab element 164E that allows the user when actuated to compare portions of the current tax return to one or more portions of a prior tax return.

The system 10 of the present invention also provides a Column soft button 166 that is displayed in the pane element 70. The Column soft button 166 when actuated displays a drop down menu box 168 that provides a list of selectable columns 170 that allows the user to hide or to include selected columns in the displayed reports. The menu box 168 can also include action buttons, such as the Apply action button 172A and the Clear action button 172B, that allows the user to apply the column selections to the displayed report or to clear the selections in the menu box. Further, the filter element or button 120 can be actuated by the user to display the dropdown menu box 176 that displays a selectable list of filters 178 that can be applied to one or more of the displayed reports. The displayed filters can vary based on the particular tab element or sub-tab element that is selected.

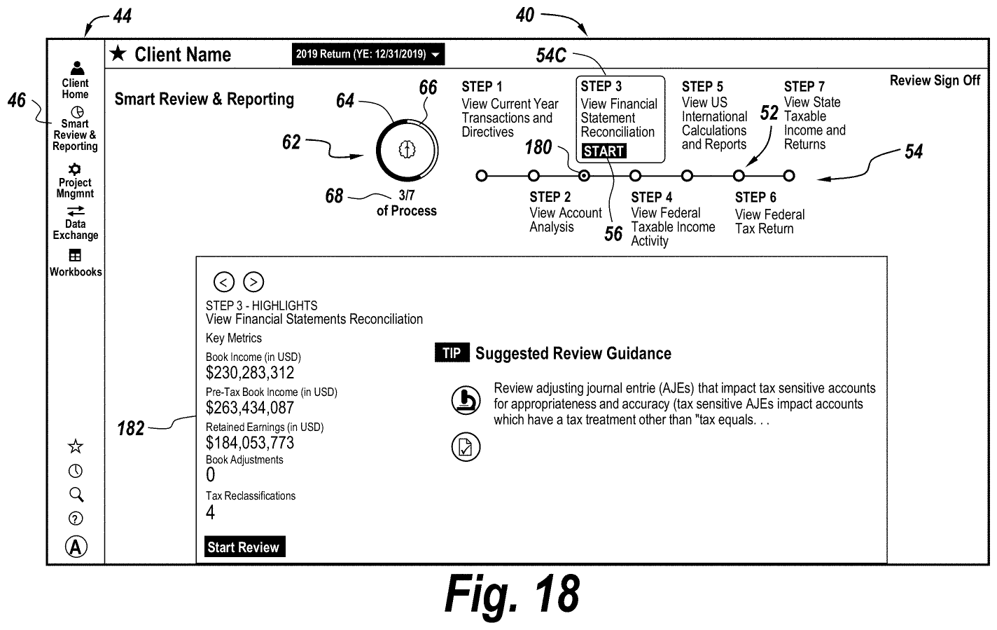

The intelligent review and processing system 10 of the present invention can allow the user through a selection device to advance the process of the present invention to Step 3—View Financial Statement Reconciliation either through use of the navigation pane 44 and associated menu pane 80 via the soft button 46, through the navigation bar 104, through actuation of one or more of the step icons 54, or through use of the navigation arrows 86A, 86B. As shown in FIG. 18, the system 10 allows the user to select Step 3 of the tax review process by actuating for example the start button 56 on the Step 3 step icon 54c. Further, the timeline waypoint graphical element 52 associated with the step icon 54c can be highlighted by the highlight icon 180 when the step icon is selected by the user. The window 40 can also include the second graphical element 62 that displays via a circular representation and associated counter the specific step in the process. For example, as shown, the graphical element 62 includes the circle element 64 that has the highlighted portion 66 that is sized to correspond to the particular step in the process. The graphical element also includes the counter element 68 that can be updated to display the step number relative to the total number of steps in the process (e.g., 3/7). The third step in the review process implemented by the intelligent review and processing system 10 of the present invention allows the user to determine the completeness, appropriateness and accuracy of adjusting journal entries that impact the tax return. The window 40 can simultaneously display general information 182 associated with Step 3. The information 182 can also be associated with the accuracy of the financial data in the tax return.

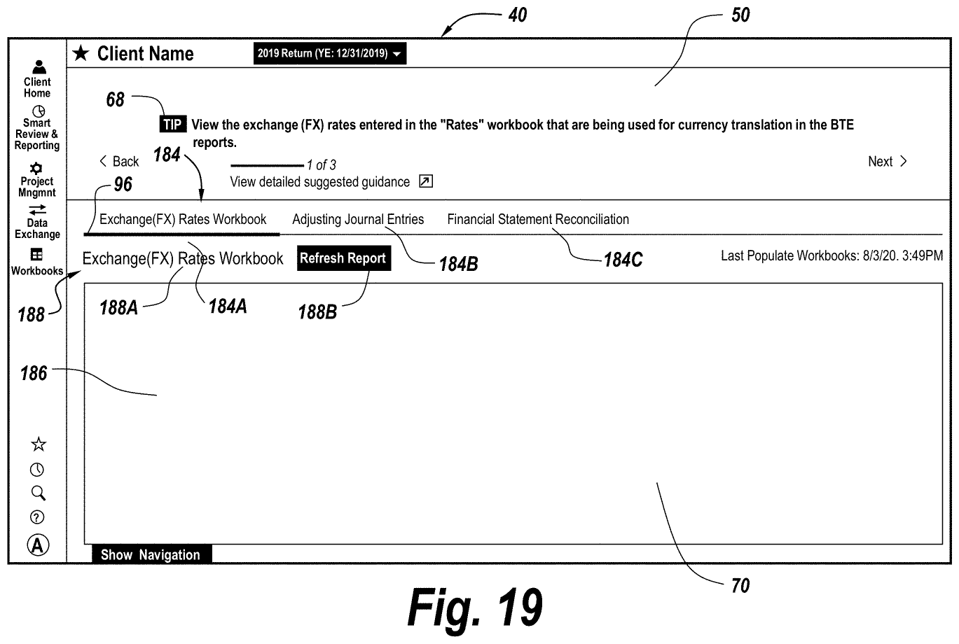

FIG. 19 illustrates the information and associated actuatable tab elements, sub-tab elements, and buttons that are displayed in the window 40 and the associated pane elements 50, 70 when Step 3 of the review process is actuated. As shown, when for example the Step 3 step icon 54c is actuated, the pane element 50 can display tip information 68 associated with the step for use by the user and the pane element 70 can display a series of report tab elements 184 and any associated information 186. The illustrated report tab elements 184 can include an Exchange Rate Workbook report tab element 184A, an Adjusting Journal Entries report tab element 184B, and a Financial Statement Reconciliation report tab element 160C. The Exchange Rate Workbook report tab element 184A can display information associated with a workbook that sets forth or contains exchange rate data. The Adjusting Journal Entries report tab element 184B displays in the pane element 70 all adjusting journal entries that are made in the federal workbook as well as any system generated adjusting entries, and the Financial Statement Reconciliation report tab element 160C processes information in the federal workbook and compares the workbook information with selected financial data in the tax return to determine if there are any discrepancies.

The illustrated tab elements 160 when actuated can also optionally have associated therewith one or more sub-tab elements. For example, when the Exchange Rate Workbook report tab element 184A is selected or actuated by the user, the report tab element 188A can have associated therewith a highlight graphical element 96 to indicate that the tab element has been actuated. Further, the Exchange Rate Workbook report tab element 184A can have the sub-tab elements 188 associated therewith. The sub-tab elements 188 can include an Exchange rate Workbook sub-tab element 188A that can display information in the pane element 70 associated with the workbook, and a Refresh Report sub-tab element 188B for refreshing any displayed report with updated financial data.

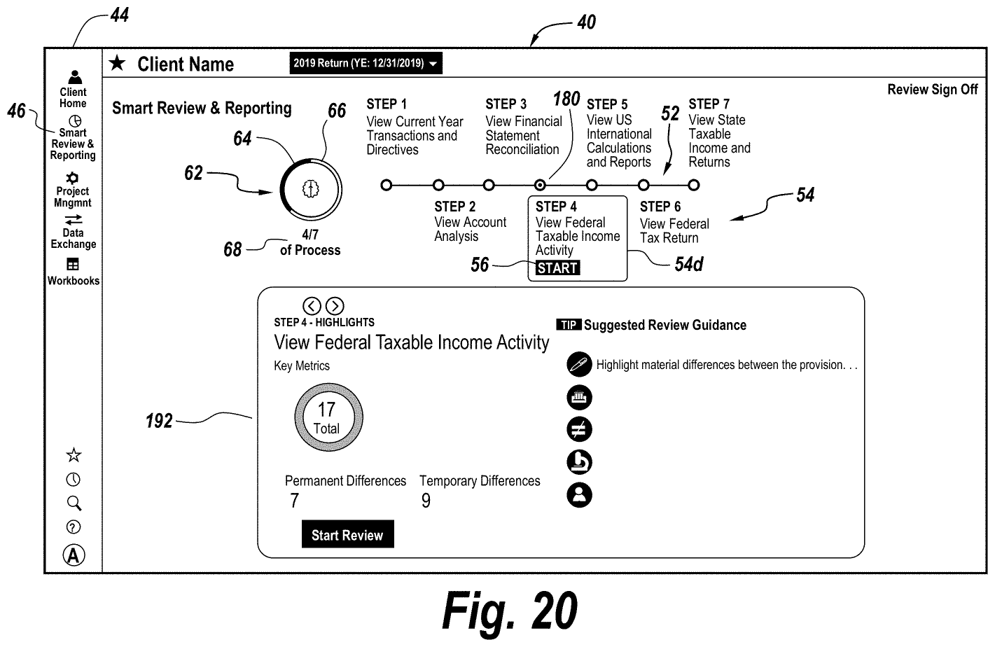

The intelligent review and processing system 10 of the present invention can allow the user through a selection device to advance the process of the present invention to Step 4—View Federal Taxable Income Activity either through use of the navigation pane 44 and associated menu pane 80 via the soft button 46, through actuation of one or more of the step icons 54, through the navigation bar 104, or through use of the navigation arrows 86A, 86B. As shown in FIG. 20, the system 10 allows the user to select Step 4 by actuating for example the start button 56 on the step icon 54d. Further, the timeline waypoint graphical element 52 associated with the step icon 54d can be highlighted by the highlight icon 180 when the step icon is selected by the user. The window 40 can also include the second graphical element 62 that displays via a circular representation and associated counter the specific step in the review process. For example, as shown, the graphical element 62 includes the circle element 64 that has the highlighted portion 66 associated therewith that is sized to correspond to the particular step in the process. The graphical element also includes the counter element 68 that can be updated to display the step number relative to the total number of steps in the process (e.g., 4/7). The fourth step in the review process implemented by the intelligent review and processing system 10 of the present invention allows the user to view the taxable income, earnings and profit of the company. The window 40 can simultaneously display general information 192 associated with Step 4.

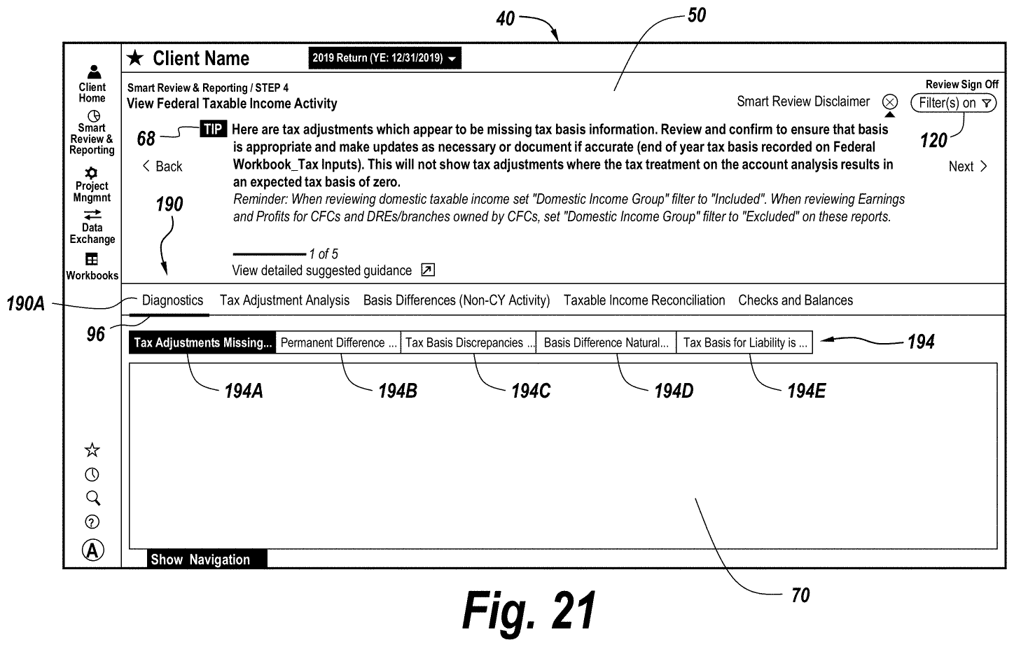

FIGS. 21-23 illustrate the information and associated actuatable tab elements, sub-tab elements, and soft buttons that are displayed in the window 40 and the associated pane elements 50, 70 when Step 4 of the tax review process is actuated. As shown, when for example the Step 4 step icon 54d is actuated, the pane element 50 can display tip information 68 associated with the step for use by the user and the pane element 70 can display a series of tab elements 190 and any associated information. The tab elements 190 include for example a Diagnostics tab element 190A, a Tax Adjustments Analysis tab element 190B, a Basis Differences tab element 190C, a Taxable Income Reconciliation tab element 190D, and a Checks and Balances tab element 190E. The Diagnostics tab element 190A displays certain financial data that was employed by the system when determining or calculating taxable income, earnings and profit. The Tax Adjustments Analysis tab element 190B provides the user with the tools to efficiently perform a risk assessment of the financial data in the tax return and to review any book tax differences. The Basis Differences tab element 190C allows the user to review and assess the completeness and accuracy of the basis differences in the financial data used in the tax return. The Taxable Income Reconciliation tab element 190D provides and displays the information associated with the taxable income calculation as well as other information, such as state tax deductions, special deductions and the like. The Checks and Balances tab element 190E displays for the user areas of the tax return that do not appear to be reconciled.

The illustrated tab elements 190 when actuated can also optionally have associated therewith one or more sub-tab elements. For example, the Diagnostics tab element 190A when selected by the user can have associated therewith the sub-tab elements 194. Further, the tab element can have associated therewith a highlight graphical element 96 that indicates that the tab element has been selected and actuated. The sub-tab elements 194 can include the Tax Adjustments Missing Tax Inputs sub-tab element 194A, the Permanent Difference Direction Diagnostic sub-tab element 194B, the Tax Basis Discrepancies sub-tab element 194C, the Basis Difference Natural Balance Diagnostics sub-tab element 194D, and the Tax Basis For Liability sub-tab element 194E. The Tax Adjustments Missing Tax Inputs sub-tab element 194A provides the user with the tools to easily and accurately determine the data that is missing that is associated with the tax adjustment data. These diagnostic reports are searching the financial data in the system for selected data patterns that an experienced tax reviewer would search so as to flag potential errors or issues for the user.

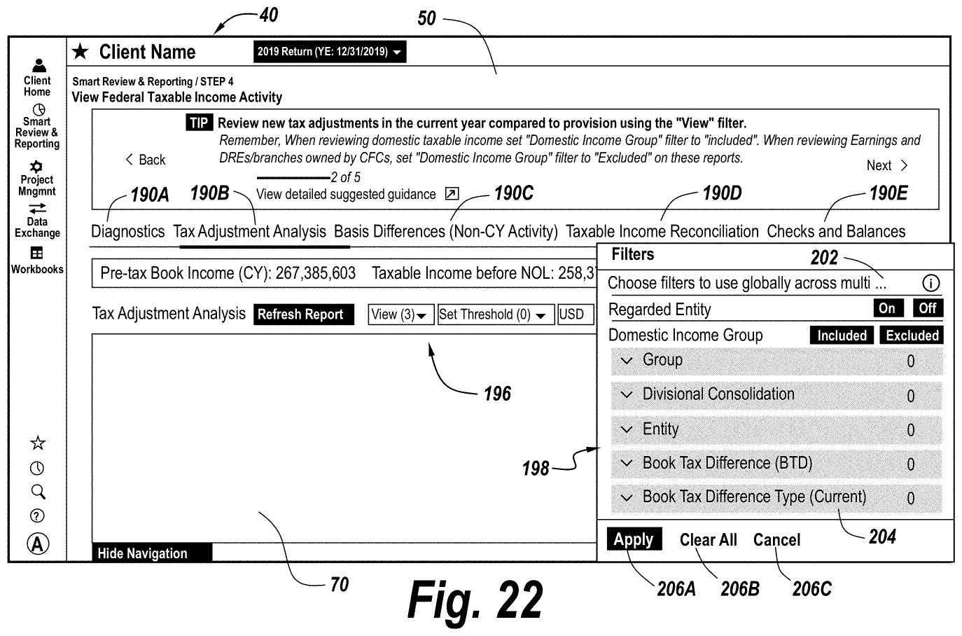

Further, as shown in FIG. 22, the Tax Adjustments Analysis tab element 190B can also be selected by the user. When selected, the tab element has the highlight graphical element associated therewith to indicate that the tab element has been actuated. The tab element 190B can also optionally have one or more sub-tab elements associated therewith. For example, the tab element 190B can have the sub-tab elements 196 associated therewith. The user can also select the filter button 120 to display a filter menu box 198. The menu box 198 can display or list one or more selectable filters 202 that can be applied to any of the information associated with the tab elements and the sub-tab elements. According to one example, the filters 204 in the filter list 202 can be displayed as selectable filter elements, or can be displayed as drop down menu elements. The menu box 198 can also include action buttons, such as the Apply action button 206A, the Clear All action button 206B, and the Cancel action button 206C, that allows the user to apply the filter selections to the displayed report or to clear the selections in the menu box. The displayed filters can vary based on the particular tab element or sub-tab element that is selected.

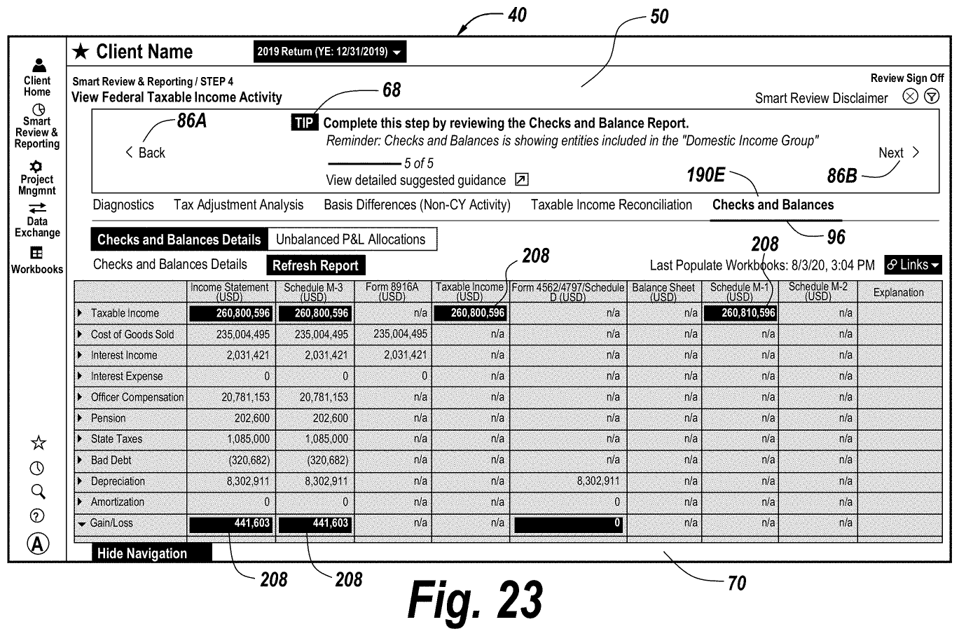

The system 10 of the present invention also processes and analyzes the information displayed in the pane element 70 to determine whether certain parts of the information warrant further review by the user. That is, the information may be incorrect or may be different than what the system expects. If this occurs, the system can highlight the aberrant data so as to visually distinguish the data so as bring the data to the attention of the user. As shown in the pane element 70 in FIG. 23, the system can process the financial data and then highlight the data that warrants further review by the user. Specifically, for example, when the Checks and Balances tab element 190E is selected and highlighted 96, the system can visually highlight or distinguish data from surrounding data or the surrounding background via the additional graphical elements 208.

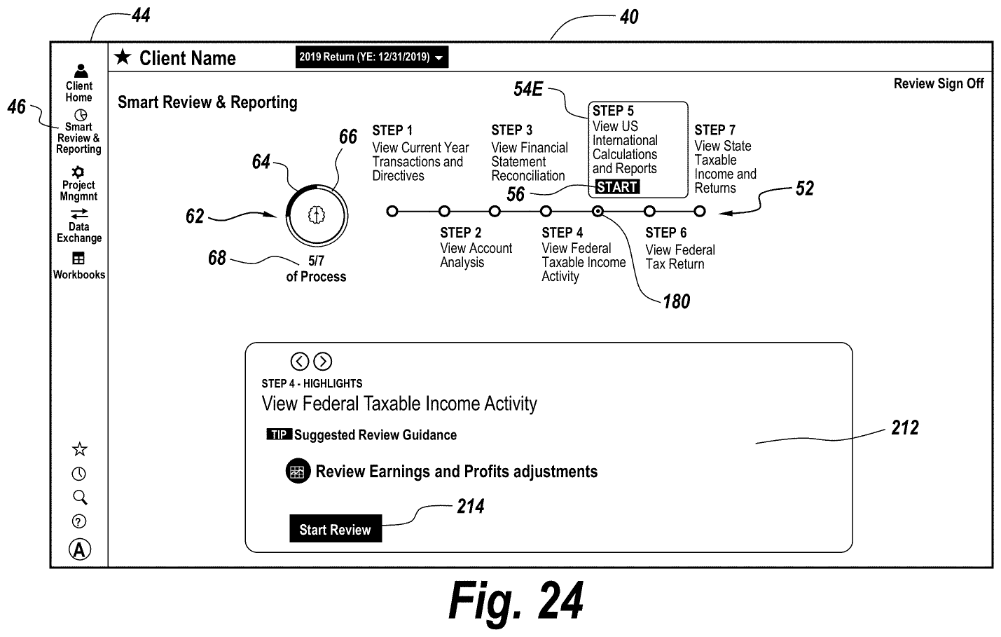

The intelligent review and processing system 10 of the present invention can allow the user through a selection device to advance the process of the present invention to Step 5—View U.S. International Calculations and Reports either through use of the navigation pane 44 and associated menu pane 80 via the soft button 46, through actuation of one or more of the step icons 54, through the navigation bar 104, or through use of the navigation arrows 86A, 86B. As shown in FIG. 24, the system 10 allows the user to select Step 5 by actuating for example the start button 56 on the step icon 54e. Further, the timeline waypoint graphical element 52 associated with the step icon 54e can be highlighted by the highlight icon 180 when the step icon is selected by the user. The window 40 can also include the second graphical element 62 that displays via a circular representation and associated counter the specific step in the tax review process. For example, as shown, the graphical element 62 includes the circle element 64 that has the highlighted portion 66 associated therewith that is sized to correspond to the particular step in the process. The graphical element also includes the counter element 68 that can be updated to display the step number relative to the total number of steps in the process (e.g., 5/7). The fifth step in the tax review process implemented by the intelligent review and processing system 10 of the present invention allows the user to review financial data related to both U.S. and international tax calculations. For example, the window 40 can also provide links if needed to one or more workbooks in order to facilitate the calculation of U.S. and international tax obligations. The window 40 can also simultaneously display general information 212 associated with Step 5. The window 40 can also have an action button 214 that the user can actuate to initiate or start the next step (e.g., Step 5) in the tax return review process.

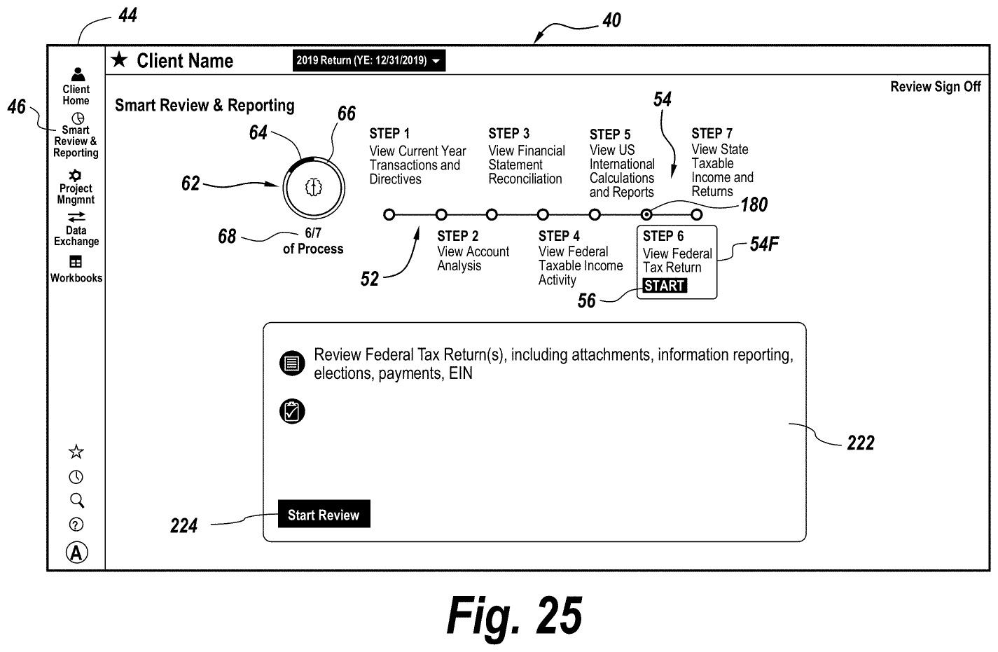

The intelligent review and processing system 10 of the present invention can allow the user through the selection device to advance the process of the present invention to Step 6—View Federal Tax Return either through use of the navigation pane 44 and associated menu pane 80 via the soft button 46, through actuation of one or more of the step icons 54, through the navigation bar 104, or through use of the navigation arrows 86A, 86B. As shown in FIG. 25, the system 10 allows the user to select Step 6 by actuating for example the start button 56 on the step icon 54f. Further, the timeline waypoint graphical element 52 associated with the step icon 54f can be highlighted by the highlight icon 180 when the step icon is selected by the user. The window 40 can also include the second graphical element 62 that displays via a circular representation and associated counter the specific step in the review process. For example, as shown, the graphical element 62 includes the circle element 64 that has the highlighted portion 66 associated therewith that is sized to correspond to the particular step in the process. The graphical element also includes the counter element 68 that can be updated to display the step number relative to the total number of steps in the process (e.g., 6/7). The sixth step in the tax review process implemented by the intelligent review and processing system 10 of the present invention allows the user to review the completed tax return including attachments, reports, elections, payments, and the like. For example, if needed, the user can also access the income statement, balance sheet, and related documents. The window 40 can also simultaneously display general information 222 associated with Step 6. The window 40 can also have an action button 224 that the user can actuate to initiate or start the next step (e.g., Step 6) in the tax return review process.

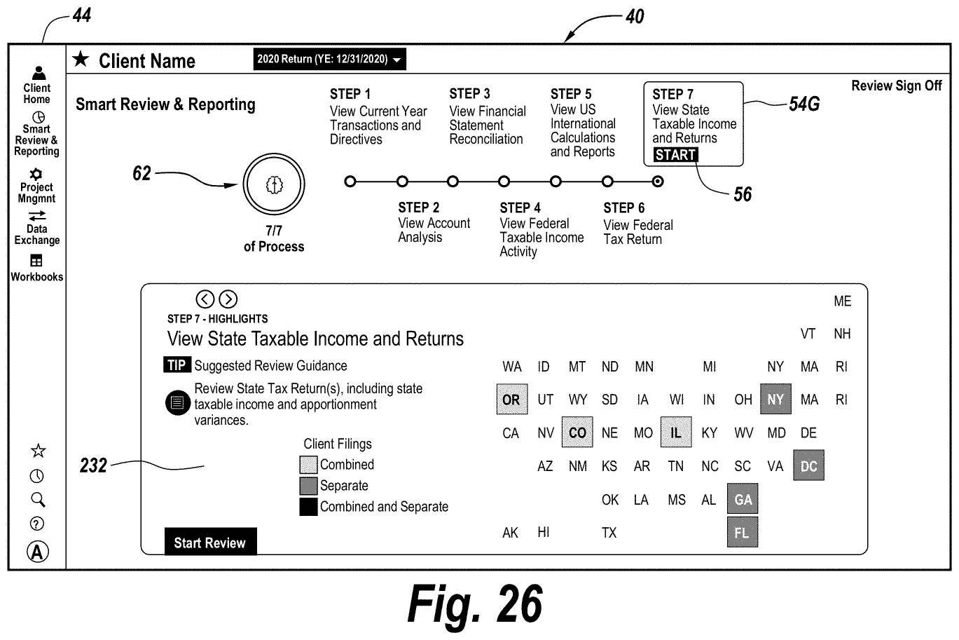

The system 10 of the present invention can also allow the user to advance the process of the present invention to Step 7—View State Taxable Income and Return. As shown in FIG. 26, the system 10 allows the user to select Step 7 by actuating for example the start button 56 on the step icon 54g. The window 40 can display or include the second graphical element 62 that displays via a circular representation and associated counter the specific step in the review process (e.g., 7/7). The seventh step in the tax review process implemented by the intelligent review and processing system 10 of the present invention allows the user to display and review the state taxable income and the state tax returns. For example, if needed, the user can also access the income statement, balance sheet, and related documents. The window 40 can also simultaneously display general information 232 associated with Step 7.

### Exemplary Hardware

Following below and referenced above are more detailed descriptions of various concepts and associated hardware of the units of the intelligent review and processing system 10 of the present invention. It should be appreciated that various concepts introduced above and discussed in greater detail below may be implemented in any number of ways, as the disclosed concepts are not limited to any particular manner of implementation. Examples of specific implementations and applications are provided below primarily for illustrative purposes and for providing or describing the operating environment of the intelligent review and processing system 10 of the present invention.

Consistent with the foregoing inventive embodiments, it is helpful to describe aspects of the operating environment as well as associated system components (e.g., hardware elements) in connection with the methods and systems described herein. For example, the intelligent review and processing system 10 of the present invention and associated sub-systems and units, including for example the data sources 12 and the electronic device 14 can be coupled together in a network environment. Further, the data sources 12, the electronic device 14, or components or units of the electronic device 14 can be implemented as clients, servers, or electronic devices as described herein. For example, as shown in FIG. 27, the components of the system 10 can be implemented in a typical network environment and one or more of the components of the intelligent review and processing system 10 can include hardware devices such as one or more clients 512a-512n (also generally referred to as local machine(s) 512, client(s) 512, client node(s) 512, client machine(s) 512, client computer(s) 512, client device(s) 512, endpoint(s) 512, or endpoint node(s) 512) in communication with one or more servers 516a-516n (also generally referred to as server(s) 516, node 516, or remote machine(s) 516) and databases via one or more networks 514. In some embodiments, a client 512 has the capacity to function as both a client node seeking access to resources provided by a server and as a server providing access to hosted resources for other clients 512a-512n. The clients can be any suitable electronic or computing device, including for example, a computer, a server, a smartphone, a smart electronic pad, a portable computer, and the like, such as the computing device 600. The various units 12, 14, 18, 20 and 22 of the intelligent review and processing system 10 of the present invention can be implemented as a client device 512 and/or a server 516 or as the electronic device 600. The data sources 12 of the system 10 can communicate with the remainder of the system 10 (e.g., the electronic device 14) via the network 514. Although FIG. 27 shows a network 514 between the clients 512 and the servers 516, the clients 512 and the servers 516 may be on the same network 514. In some embodiments, there are multiple networks 514 between the clients 512 and the servers 516. In one of these embodiments, a network 514′ (not shown) may be a private network and a network 514 may be a public network. In another of these embodiments, a network 514 may be a private network and a network 514′ a public network. In still another of these embodiments, networks 514 and 514′ may both be private networks. In the current embodiment, the data sources can be represented as the clients 512 and the electronic device and associated components can be represented by the servers 516.

The network 514 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 514 may be any type and/or form of network. The geographical scope of the network 514 may vary widely and the network 514 can be a body area network (BAN), a personal area network (PAN), a local-area network (LAN), e.g. Intranet, a metropolitan area network (MAN), a wide area network (WAN), or the Internet. The topology of the network 514 may be of any form and may include, e.g., any of the following: point-to-point, bus, star, ring, mesh, or tree. The network 514 may be an overlay network, which is virtual and sits on top of one or more layers of other networks 514′. The network 514 may be of any such network topology as known to those ordinarily skilled in the art capable of supporting the operations described herein. The network 514 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 514 may be a type of a broadcast network, a telecommunications network, a data communication network, or a computer network.

In some embodiments, the network system may include multiple, logically-grouped servers 516. In one of these embodiments, the logical group of servers may be referred to as a server farm 518 or a machine farm 518. In another of these embodiments, the servers 516 may be geographically dispersed. In other embodiments, a machine farm 518 may be administered as a single entity. In still other embodiments, the machine farm 518 includes a plurality of machine farms 518. The servers 516 within each machine farm 518 can be heterogeneous, and one or more of the servers 516 or machines 516 can operate according to one type of operating system platform (e.g., WINDOWS NT, manufactured by Microsoft Corp. of Redmond, Wash.), while one or more of the other servers 516 can operate according to another type of operating system platform (e.g., Unix, Linux, or Mac OS X).

In one embodiment, servers 516 in the machine farm 518 may be stored in high-density rack systems, along with associated storage systems, and located in an enterprise data center. In this embodiment, consolidating the servers 516 in this way may improve system manageability, data security, the physical security of the system, and system performance by locating servers 516 and high performance storage systems on localized high performance networks. Centralizing the servers 516 and storage systems and coupling them with advanced system management tools allows more efficient use of server resources.

The servers 516 of each machine farm 518 do not need to be physically proximate to another server 516 in the same machine farm 518. Thus, the group of servers 516 logically grouped as a machine farm 518 may be interconnected using a wide-area network (WAN) connection or a metropolitan-area network (MAN) connection. For example, a machine farm 518 may include servers 516 physically located in different continents or different regions of a continent, country, state, city, campus, or room. Data transmission speeds between servers 516 in the machine farm 518 can be increased if the servers 516 are connected using a local-area network (LAN) connection or some form of direct connection. Additionally, a heterogeneous machine farm 518 may include one or more servers 516 operating according to a type of operating system, while one or more other servers 516 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 518 may be de-centralized. For example, one or more servers 516 may comprise components, subsystems and modules to support one or more management services for the machine farm 518. In one of these embodiments, one or more servers 516 provide functionality for management of dynamic data, including techniques for handling failover, data replication, and increasing the robustness of the machine farm 518. Each server 516 may communicate with a persistent store and, in some embodiments, with a dynamic store.

Server 516 may be a file server, application server, web server, proxy server, appliance, network appliance, gateway, gateway server, virtualization server, deployment server, SSL VPN server, or firewall, or any other suitable computing device, such as computing device 600. In one embodiment, the server 516 may be referred to as a remote machine or a node. In another embodiment, a plurality of nodes may be in the path between any two communicating servers. The units 12, 14, 18 and 20 of the order fulfillment system 10, FIG. 1, as well as the warehouse map unit 120, cart building unit 128 and the graph generating unit 124 of the present invention can be stored or implemented on one or more of the servers 516 or clients 512, and the hardware associated with the server or client, such as the processor or CPU and memory.

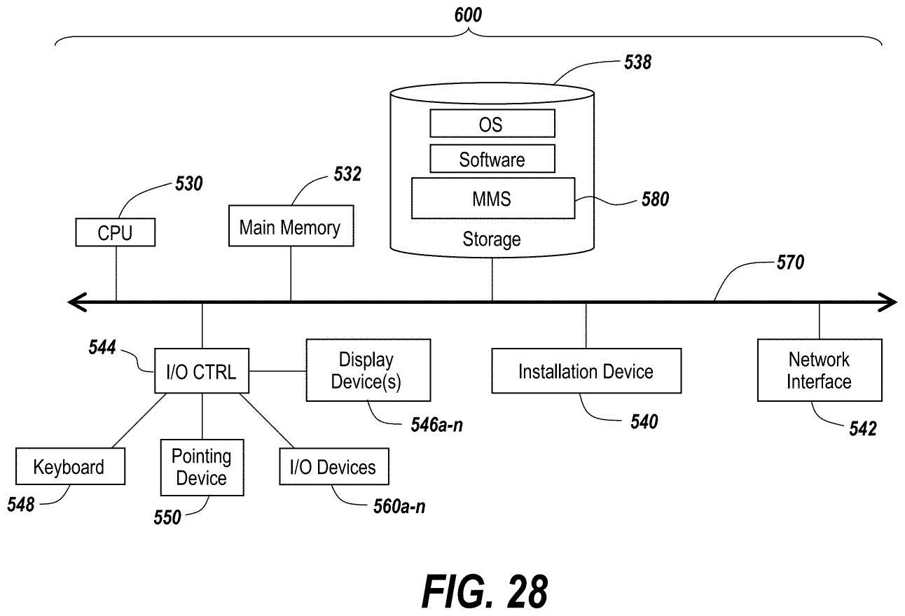

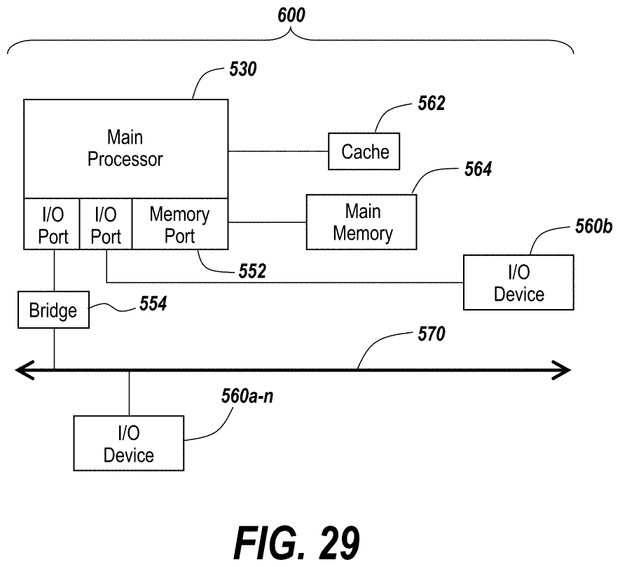

The client 512 and server 516 may be deployed as and/or executed on any type and form of computing device, such as for example a computer, network device or appliance capable of communicating on any type and form of network and performing the operations described herein. FIGS. 28 and 29 depict block diagrams of an electronic or computing device 600 useful for practicing an embodiment of the client 512 and/or a server 516, and thus by extension any unit or combination of units 12, 14, 18 and 22 of the intelligent review and processing system 10 of the present invention. As shown in FIGS. 28 and 29, each electronic device 600 includes a central processing unit 530, and a main memory unit 532. As shown in FIG. 28, the electronic device 600 may include a storage device 538, an installation device 540, a network interface 542, an I/O controller 544, display devices 546a-546n, a keyboard 548 and a pointing device 550, e.g. a mouse. The storage device 538 may include, without limitation, an operating system, and/or software. As shown in FIG. 29, each electronic device 600 may also include additional optional elements, e.g. a memory port 552, a bridge 554, one or more input/output devices 560a-560n (generally referred to using reference numeral 560), and a cache memory 562 in communication with the central processing unit 530.

The central processing unit 530 is any logic circuitry that responds to and processes instructions fetched from the main memory unit 564. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The electronic device 600 may be based on any of these processors, or any other processor capable of operating as described herein. The central processing unit 530 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit or main memory storage unit 564 may include one or more memory chips capable of storing data and allowing any storage location to be directly accessed by the processor 530. The main memory unit 564 may be volatile and faster than memory of the storage unit 538. Main memory units 564 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 564 or the storage 538 may be non-volatile, e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 564 may be based on any of the above described memory chips, or any other available memory chips capable of operating as described herein. In the embodiment shown in FIG. 28, the processor 530 communicates with main memory 532 via a system bus 570 (described in more detail below). FIG. 29 depicts an embodiment of the electronic device 600 in which the processor communicates directly with main memory 564 via a memory port 552. For example, in FIG. 29 the main memory 564 may be DRDRAM. The computer executable instructions of the present invention may be provided using any computer-readable media that is accessible by the computing or electronic device 600. Computer-readable media may include, for example, the computer memory or storage unit 564, 538 described above. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 564, 538 is shown within the electronic device 600 it will be appreciated that the storage may be distributed or located remotely and accessed via a network or other communication link.

FIG. 29 depicts an embodiment in which the main processor 530 communicates directly with cache memory 562 via a secondary bus, sometimes referred to as a backside bus. In other embodiments, the main processor 530 communicates with cache memory 562 using the system bus 570. Cache memory 562 typically has a faster response time than main memory 564 and is typically provided by SRAM, B SRAM, or EDRAM. In the embodiment shown in FIG. 29, the processor 530 communicates with various I/O devices 560 via a local system bus 570. Various buses may be used to connect the central processing unit 530 to any of the I/O devices 560, including a PCI bus, a PCI-X bus, or a PCI-Express bus, or a NuBus. For embodiments in which the I/O device is a video display 546, the processor 530 may use an Advanced Graphics Port (AGP) to communicate with the display 546 or the I/O controller 544 for the display 546. FIG. 29 depicts an embodiment of a computer 600 in which the main processor 530 communicates directly with I/O device 560b or other processors 530 via HYPERTRANSPORT, RAPIDIO, or INFINIBAND communications technology. FIG. 29 also depicts an embodiment in which local busses and direct communication are mixed: the processor 530 communicates with I/O device 560a using a local interconnect bus while communicating with I/O device 560b directly.

A wide variety of I/O devices 560a-560n may be present in the computing device 600. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, and printers such as inkjet printers, laser printers, and 3D printers.

Additional devices 560a-560n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXEL SENSE or Multi-Touch Collaboration Wall, may have larger surfaces, such as on a table-top or on a wall, and may also interact with other electronic devices. Some I/O devices 560a-560n, display devices 546a-546n or group of devices may be augment reality devices. The I/O devices may be controlled by an I/O controller 44 as shown in FIG. 19. The I/O controller may control one or more I/O devices, such as, e.g., a keyboard 548 and a pointing device 550, e.g., a mouse or optical pen. Furthermore, an I/O device may also provide storage and/or an installation medium 540 for the computing device 600. In still other embodiments, the computing device 600 may provide USB connections (not shown) to receive handheld USB storage devices. In further embodiments, an I/O device 560 may be a bridge between the system bus 570 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 546a-546n may be connected to I/O controller 544. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 546a-546n may also be a head-mounted display (HMD). In some embodiments, display devices 546a-546n or the corresponding I/O controllers 544 may be controlled through or have hardware support for OPENGL or DIRECTX API or other graphics libraries.

In some embodiments, the electronic device 600 may include or connect to multiple display devices 546a-546n, which each may be of the same or different type and/or form. As such, any of the I/O devices 26, 560a-560n and/or the I/O controller 544 may include any type and/or form of suitable hardware, software, or combination of hardware and software to support, enable or provide for the connection and use of multiple display devices 546a-546n by the electronic device 600. For example, the electronic device 600 may include any type and/or form of video adapter, video card, driver, and/or library to interface, communicate, connect or otherwise use the display devices 546a-546n. In one embodiment, a video adapter may include multiple connectors to interface to multiple display devices 546a-546n. In other embodiments, the computing device 600 may include multiple video adapters, with each video adapter connected to one or more of the display devices 546a-546n. In some embodiments, any portion of the operating system of the electronic device 600 may be configured for using multiple displays 546a-546n. In other embodiments, one or more of the display devices 546a-546n may be provided by one or more other computing devices 600a or 600b connected to the electronic device 600, via the network 514. In some embodiments software may be designed and constructed to use another computer's display device as a second display device 546a for the computing device 600. For example, in one embodiment, an Apple iPad may connect to a electronic device 600 and use the display of the device 600 as an additional display screen that may be used as an extended desktop. One ordinarily skilled in the art will recognize and appreciate the various ways and embodiments that a computing device 600 may be configured to have multiple display devices 546a-546n.

Referring again to FIG. 28, the electronic device 600 may comprise a storage device 538 (e.g. one or more hard disk drives or redundant arrays of independent disks) for storing an operating system or other related software, and for storing application software programs such as any program related to the software 580 for the order fulfillment system 10 of the present invention. Examples of storage devices 538 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. The storage device 538 may be non-volatile, mutable, or read-only. The storage device 538 may be internal and connect to the electronic device 600 via a bus 570. Further, the storage device 538 may be external and connect to the computing device 600 via an I/O device 560 that provides an external bus. Some storage devices 538 may connect to the computing device 600 via the network interface 542 over a network 514, including, e.g., the Remote Disk for MACBOOK AIR by Apple. Some client devices 512 may not require a non-volatile storage device 538 and may be thin clients or zero clients 512. The storage device 538 may also be used as an installation device 540, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Furthermore, the electronic device 600 may include a network interface 542 to interface to the network 514 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 600 communicates with other computing devices 600′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 542 may comprise a built-in network adapter, network interface card, PCMCIA network card, EXPRESSCARD network card, card bus network adapter, wireless network adapter, USB network adapter, modem or any other device suitable for interfacing the computing device 600 to any type of network capable of communication and performing the operations described herein.

The electronic device 600 of the sort depicted in FIG. 28 may operate under the control of an operating system, which controls scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOK S.

The electronic system 600 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 600 has sufficient processor power and memory capacity to perform the operations described herein. In some embodiments, the electronic device 600 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the electronic device 600 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the electronic device 600 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the electronic device 600 is a tablet e.g. the IPAD line of devices by Apple; GALAXY TAB family of devices by Samsung; or KINDLE FIRE, by Amazon.com, Inc. of Seattle, Wash. In other embodiments, the computing device 600 is an eBook reader, e.g. the KINDLE family of devices by Amazon.com, or NOOK family of devices by Barnes & Noble, Inc. of New York City, N.Y. In some embodiments, the electronic device 600 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the electronic device 600 is a laptop or desktop computer equipped with a web browser and a microphone and speaker system, e.g. a telephony headset. In these embodiments, the computing devices 600 are web-enabled and can receive and initiate phone calls. In some embodiments, a laptop or a desktop computer is also equipped with a webcam or other video capture device that enables video chat and video call. In some embodiments, the computing device 600 is a wearable mobile computing device including but not limited to Google Glass and Samsung Gear.

In some embodiments, the status of one or more machines 512, 516 in the network 514 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the order fulfillment system disclosed herein.

The foregoing description may provide illustration and description of various embodiments of the invention, but is not intended to be exhaustive or to limit the invention to the precise form disclosed. Modifications and variations of the order fulfillment system of the present invention may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware. Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

Further, the invention can be employed using any combination of features or elements as described above, and are not limited to the current recited steps or features.

It is intended that the invention not be limited to the particular embodiments disclosed above, but that the invention will include any and all particular embodiments and equivalents falling within the scope of the following appended claims.

We claim:

1. An intelligent review and processing system, comprising one or more sources of financial data,
an electronic device having
a processor for processing the financial data,
a storage element for storing the financial data, and
a report generator for generating one or more reports from the financial data, the report generator having a user interface generator for generating a plurality of user interfaces each having a window element that displays selected portions of the processed financial data, wherein the window element of the user interfaces includes:
a navigation pane formed along a left side of the window element having an actuatable soft button for accessing one or more portions of a tax review sequence having a plurality of tax review steps,
a top pane element for displaying tip information and associated guidance, and
a bottom pane element for displaying information associated with one or more of the plurality of tax review steps, and
wherein one or more of the plurality of user interfaces has a window element that includes a graphical element representative of the plurality of tax review steps.

2. The system of claim 1, wherein the window element further comprises a header pane that is disposed or located at a topmost portion of the window element.

3. The system of claim 1, wherein the graphical element comprises a graphical timeline element having a plurality of waypoint elements associated therewith, wherein each of the plurality of waypoint elements has associated therewith a step icon element representative of one of the plurality of tax review steps, and wherein each of the step icon elements has associated therewith an actuatable soft button.

4. The system of claim 3, wherein one or more of the step icon elements and the navigation pane, when the associated soft button is actuated, comprises
a Step 1 View Current Year Transactions step icon element for displaying, when actuated, financial data related to current year transactions and deliverables of a company,
a Step 2 View Accounts Analysis step icon element for displaying, when actuated, financial data related to a taxable income of the company,
a Step 3 View Financial Statement Reconciliation step icon element for displaying when actuated financial data associated with a tax return of the company,
a Step 4 View Federal Tax Income Activity step icon element for displaying when actuated financial data associated with the taxable income, earnings, and profits of the company,
a Step 5 View US International Calculations and Reports step icon element for displaying when actuated financial data associated with one or more selected workbooks,
a Step 6 View Federal Tax Return step icon element for displaying when actuated the tax return of the company, and
a Step 7 View State Taxable Income and Returns step icon element for displaying when actuated financial data related to state related financial information,
wherein each of the step icon elements is associated with a respective one of the plurality of waypoint elements.

5. The system of claim 4, wherein the actuatable soft button associated with each of the step icon elements comprises an actuatable Start soft button for displaying, when actuated, one or more of the user interfaces associated with the tax review step associated therewith.

6. The system of claim 5, wherein the graphical element includes a circular graphical element and an associated counter element representative of the selected tax review step.

7. The system of claim 6, wherein the circular graphical element further comprises a highlight graphical element for visually highlighting a selected portion of the circular graphical element.

8. The system of claim 6, further comprising a back navigation icon element disposed adjacent to the circular graphical element for navigating through the plurality of tax review steps in a descending order, and a forward navigation icon element disposed opposite to the back navigation icon element for navigating through the plurality of tax review steps in an ascending order.

9. The system of claim 8, wherein the window element further comprises a hideable navigation bar disposed on a bottommost portion thereof and below and adjacent to the bottom pane element, wherein the navigation bar includes a plurality of navigation icons, wherein each of the navigation icons corresponds to each of the plurality of tax review steps.

10. The system of claim 9, wherein the navigation bar is hideable by selecting a soft button associated with the navigation bar.

11. The system of claim 5, further comprising a menu box that is displayed in the window element when the actuatable soft button in the navigation pane is actuated by a user, wherein the menu box displays the plurality of tax review steps.

12. The system of claim 1, wherein the top pane element includes an actuatable filter button that allows the user to select one or data filters from a list of data filters.

13. The system of claim 4, wherein the bottom pane element displays information associated with each of the plurality of tax review steps, and wherein one or more of the plurality of tax review steps includes a plurality of actuatable tab elements.

14. The system of claim 13, wherein when the Step 1 View Current Year Transactions step icon element is actuated, the bottom pane element displays the plurality of tab elements, and the plurality of tab elements includes one or more of:
a Current Year Transactions tab element that allows the user to document and analyze a current year transaction data portion of the financial data,
an Entity Change Analysis tab element that allows the user to review changes to the entity structure of the company and to analyze any impact of the changes,
a Deliverables Analysis tab element that allows the user to review the completeness and accuracy of a deliverables portion of the financial data,
an Acquisition Method Accounting tab element that allows the user to review acquisition information that affects a tax obligation of the company; and
an Equity Movement tab element that allows the user to review and analyze equity activity of the company.

15. The system of claim 14, wherein, when the Entity Change Analysis tab element is actuated, the bottom pane element displays a plurality of sub-tab elements comprising one or more of:
a Refresh Report sub-tab element for refreshing information within one or more reports generated by the report generator,
a View sub-tab element for viewing one or more selectable fields for applying an associated filter to the financial data,
a Compare PY Return to CY Return sub-tab element for comparing the financial data in a current year tax return to financial data in a prior year tax return, and
a Compare CY Provision to CY Return sub-tab element for allowing the user to compare the financial data in the current year tax return with the financial data in a selected tax income provision.

16. The system of claim 15, wherein when the View sub-tab element is actuated, the pane element displays a drop down menu that includes a plurality of selectable fields indicative of information related to the entity structure.

17. The system of claim 16, wherein the plurality of selectable fields includes one or more of an entity name field, entity type field, new entities field, terminated entities field, ownership field, and a functional currency field.

18. The system of claim 17, wherein the drop down menu includes a plurality of action buttons.

19. The system of claim 15, further comprising, when the Deliverables Analysis tab element is actuated, the bottom pane element displays a plurality of sub-tab elements comprising
a Potential Nexus Activity report tab element for displaying financial data associated with state apportionment activity, and
a Changes to Filing Group report tab element for comparing and displaying information associated with one or more entities of a company of a current calendar year with similar data from a prior selected year.

20. The system of claim 19, further comprising, when the Acquisition Method Accounting tab element is actuated, the bottom pane element displays a plurality of sub-tab elements comprising
a Temporary Difference sub-tab element for displaying information associated with an acquisition method accounting of the company, and
an Impact on Permanent Differences sub-tab element for displaying information associated with transaction costs and book tax differences of the company.

21. The system of claim 20, wherein, when the Equity Movement tab element is actuated, the bottom pane element displays a plurality of sub-tab elements comprising one or more of:
a Summary of retained Earnings Activity sub-tab element for displaying financial data associated with retained earnings of the company,
a Summary of Additional Paid in Capital Activity sub-tab element for displaying financial data related to capital of the company,
a Summary of the Common Stock Activity sub-tab element for displaying financial data related to common stock of the company,
a Summary of the Preferred Stock Activity sub-tab element for displaying financial data related to preferred stock of the company, and
a Summary of Treasury Stock Activity sub-tab element for displaying financial data associated with activity involving treasury stock.

22. The system of claim 13, wherein when the Step 2 View Accounts Analysis step icon element is actuated the bottom pane element displays a second plurality of tab elements, wherein the second plurality of tab elements includes one or more of:
a New Accounts tab element for displaying when actuated selected portions of the financial data related to new general ledger accounts of the company,
an Incomplete Mappings tab element for displaying when actuated one or more accounts where an analysis of the accounts has not yet been completed,
a Deleted Accounts tab element for displaying when actuated the one or more accounts in a prior year tax return or provision that are absent from a current year tax return,
a Change in Mappings tab element for displaying when actuated the one or more accounts of the company that has mapping changes,
a Complete Mappings tab element for displaying when actuated one or more accounts of the company that have been mapped and displaying details associated with the mapping, and
a Standard BTD Mapping tab element.

23. The system of claim 13, wherein when the Step 3 View Financial Statement Reconciliation step icon element is actuated, the bottom pane element displays a third plurality of tab elements, wherein the third plurality of tab elements includes
an Exchange Rate Workbook report tab element for displaying, when actuated, information associated with exchange rates being employed in a project employing the tax steps and used for translating financial data into one or more foreign currencies,
an Adjusting Journal Entries report tab element for displaying one or more of the journal entries in the project, and
a Financial Statement Reconciliation report tab element for displaying when actuated any differences between financial data entries in the workbook with selected financial data in the tax return.

24. The system of claim 13, wherein when the Step 4 View Federal Tax Income Activity step icon element is actuated, the bottom pane element displays a fourth plurality of tab elements, wherein the fourth plurality of tab elements includes one or more of:
a Diagnostics tab element for displaying, when actuated, the financial data employed to determine a taxable income, earnings and profit of the company and for allowing the user to review selected patterns in the financial data indicative of one or more errors,
a Tax Adjustments Analysis tab element for displaying when actuated the financial data employed to determine a book tax difference of the company and to perform a risk based review of the book tax differences,
a Basis Differences tab element for allowing when actuated the user to review and assess an accuracy of a basis difference in the financial data used in the tax return not affecting taxable income of the company,
a Taxable Income Reconciliation tab element for displaying when actuated information associated with a reconciliation of the taxable income of the company in comparison to one or more previous income tax provisions, and
a Checks and Balances tab element for displaying when actuated selected portions of the tax return of the company to ensure that certain aspects thereof are reconciled.

25. A computer implemented method, comprising
receiving financial data from one or more data sources,
processing and storing the financial data,
generating one or more reports from the financial data with a report generator, the report generator having a user interface generator for generating a plurality of user interfaces each having a window element that displays selected portions of the processed financial data, wherein the window element of one or more of the user interfaces includes:
a navigation pane formed along a left side of the window element having an actuatable soft button for accessing one or more portions of a tax review sequence having a plurality of tax review steps,
a top pane element for displaying tip information and guidance, and
a bottom pane element for displaying information associated with one or more of the plurality of tax review steps, and
wherein one or more of the plurality of user interfaces has a window element that includes a graphical element representative of the plurality of tax review steps.

26. The computer implemented method of claim 25, wherein the window element further comprises a header pane that is disposed or located at a topmost portion of the window element.

27. The computer implemented method of claim 25, wherein the graphical element comprises a graphical timeline element having a plurality of waypoint elements associated therewith, wherein each of the plurality of waypoint elements has associated therewith a step icon element representative of one of the plurality of tax review steps, and wherein each of the step icon elements has associated therewith an actuatable soft button.

28. The computer implemented method of claim 27, wherein one or more of the step icon elements and the navigation pane, when the associated soft button is actuated, comprises
a Step 1 View Current Year Transactions step icon element for displaying, when actuated, financial data related to current year transactions and deliverables of a company,
a Step 2 View Accounts Analysis step icon element for displaying, when actuated, financial data related to a taxable income of the company,
a Step 3 View Financial Statement Reconciliation step icon element for displaying when actuated financial data associated with a tax return of the company,
a Step 4 View Federal Tax Income Activity step icon element for displaying when actuated financial data associated with the taxable income, earnings, and profits of the company,
a Step 5 View US International Calculations and Reports step icon element for displaying when actuated financial data associated with one or more selected workbooks,
a Step 6 View Federal Tax Return step icon element for displaying when actuated the tax return of the company, and
a Step 7 View State Taxable Income and Returns step icon element for displaying when actuated financial data related to state related financial information,
wherein each of the step icon elements is associated with a respective one of the plurality of waypoint elements.

29. The computer implemented method of claim 28, wherein the actuatable soft button associated with each of the step icon elements comprises an actuatable Start soft button for displaying, when actuated, one or more of the user interfaces associated with the tax review step associated therewith.

30. The computer implemented method of claim 29, wherein the graphical element includes a circular graphical element and an associated counter element representative of the selected tax review step.

31. The computer implemented method of claim 30, further comprising visually highlighting a selected portion of the circular graphical element with a highlight graphical.

32. The computer implemented method of claim 30, further comprising disposing a back navigation icon element adjacent to the circular graphical element for navigating through the plurality of tax review steps in a descending order, and disposing a forward navigation icon element opposite to the back navigation icon element for navigating through the plurality of tax review steps in an ascending order.

33. The computer implemented method of claim 32, further comprising disposing a hideable navigation bar on a bottommost portion of the window element and below and adjacent to the bottom pane element, wherein the navigation bar includes a plurality of navigation icons, wherein each of the navigation icons corresponds to each of the plurality of tax review steps.

34. The computer implemented method of claim 33, further comprising hiding the navigation bar by selecting a soft button associated with the navigation bar.

35. The computer implemented method of claim 29, further comprising displaying a menu box in the window element when the actuatable soft button in the navigation pane is actuated by a user, wherein the menu box displays the plurality of tax review steps.

36. The computer implemented method of claim 25, further comprising providing in the top pane element an actuatable filter button that allows the user to select one or data filters from a list of data filters.

37. The computer implemented method of claim 28, wherein the bottom pane element displays information associated with each of the plurality of tax review steps, and wherein one or more of the plurality of tax review steps includes a plurality of actuatable tab elements.

38. The computer implemented method of claim 37, wherein when the Step 1 View Current Year Transactions step icon element is actuated, the bottom pane element displays the plurality of tab elements, and the plurality of tab elements includes one or more of:
a Current Year Transactions tab element that allows the user to document and review a current year transaction data portion of the financial data,
an Entity Change Analysis tab element that allows the user to review changes to the entity structure of the company and to analyze any impact of the changes,
a Deliverables Analysis tab element that allows the user to review the completeness and accuracy of a deliverables portion of the financial data,
an Acquisition Method Accounting tab element that allows the user to review acquisition information that affects a tax obligation of the company; and
an Equity Movement tab element that allows the user to review and analyze equity activity of the company.

39. The computer implemented method of claim 38, wherein, when the Entity Change Analysis tab element is actuated, the bottom pane element displays a plurality of sub-tab elements comprising one or more of:
a Refresh Report sub-tab element for refreshing information within one or more reports generated by the report generator,
a View sub-tab element for viewing one or more selectable fields for applying an associated filter to the financial data,
a Compare PY Return to CY Return sub-tab element for comparing the financial data in a current year tax return to financial data in a prior year tax return, and
a Compare CY Provision to CY Return sub-tab element for allowing the user to compare the financial data in the current year tax return with the financial data in a selected tax income provision.

40. The computer implemented method of claim 39, wherein when the View sub-tab element is actuated, the pane element displays a drop down menu that includes a plurality of selectable fields indicative of information related to the entity structure.

41. The computer implemented method of claim 40, wherein the plurality of selectable fields includes one or more of an entity name field, entity type field, new entities field, terminated entities field, ownership field, and a functional currency field.

42. The computer implemented method of claim 41, wherein the drop down menu includes a plurality of action buttons.

43. The computer implemented method of claim 38, further comprising, when the Deliverables Analysis tab element is actuated, the bottom pane element displays a plurality of sub-tab elements comprising
a Potential Nexus Activity report tab element for displaying financial data associated with state apportionment activity, and
a Changes to Filing Group report tab element for comparing and displaying information associated with one or more entities of a company of a current calendar year with similar data from a prior selected year.

44. The computer implemented method of claim 43, further comprising, when the Acquisition Method Accounting tab element is actuated, the bottom pane element displays a plurality of sub-tab elements comprising
a Temporary Difference sub-tab element for displaying information associated with an acquisition method accounting of the company, and
an Impact on Permanent Differences sub-tab element for displaying information associated with transaction costs and book tax differences of the company.

45. The computer implemented method of claim 44, wherein, when the Equity Movement tab element is actuated, the bottom pane element displays a plurality of sub-tab elements comprising one or more of:
a Summary of retained Earnings Activity sub-tab element for displaying financial data associated with retained earnings of the company,
a Summary of Additional Paid in Capital Activity sub-tab element for displaying financial data related to capital of the company,
a Summary of the Common Stock Activity sub-tab element for displaying financial data related to common stock of the company,
a Summary of the Preferred Stock Activity sub-tab element for displaying financial data related to preferred stock of the company, and
a Summary of Treasury Stock Activity sub-tab element for displaying financial data associated with activity involving treasury stock.

46. The computer implemented method of claim 37, wherein when the Step 2 View Accounts Analysis step icon element is actuated, the bottom pane element displays a second plurality of tab elements, wherein the second plurality of tab elements includes one or more of:
a New Accounts tab element for displaying when actuated selected portions of the financial data related to new general ledger accounts of the company,
an Incomplete Mappings tab element for displaying when actuated one or more accounts where an analysis of the accounts has not yet been completed,
a Deleted Accounts tab element for displaying when actuated the one or more accounts in a prior year tax return or provision that are absent from a current year tax return,
a Change in Mappings tab element for displaying when actuated the one or more accounts of the company that has mapping changes,
a Complete Mappings tab element for displaying when actuated one or more accounts of the company that have been mapped and displaying details associated with the mapping, and
a Standard BTD Mapping tab element.

47. The computer implemented method of claim 37, wherein when the Step 3 View Financial Statement Reconciliation step icon element is actuated, the bottom pane element displays a third plurality of tab elements, wherein the third plurality of tab elements includes
an Exchange Rate Workbook report tab element for displaying, when actuated, information associated with exchange rates being employed in a project employing the tax steps and used for translating financial data into one or more foreign currencies,
an Adjusting Journal Entries report tab element for displaying one or more of the journal entries in the project, and
a Financial Statement Reconciliation report tab element for displaying when actuated any differences between financial data entries in the workbook with selected financial data in the tax return.

48. The computer implemented method of claim 37, wherein when the Step 4 View Federal Tax Income Activity step icon element is actuated, the bottom pane element displays a fourth plurality of tab elements, wherein the fourth plurality of tab elements includes one or more of:
a Diagnostics tab element for displaying, when actuated, the financial data employed to determine a taxable income, earnings and profit of the company and for allowing the user to review selected patterns in the financial data indicative of one or more errors,
a Tax Adjustments Analysis tab element for displaying when actuated the financial data employed to determine a book tax difference of the company and to perform a risk based review of the book tax differences,
a Basis Differences tab element for allowing when actuated the user to review and assess an accuracy of a basis difference in the financial data used in the tax return not affecting taxable income of the company,
a Taxable Income Reconciliation tab element for displaying when actuated information associated with a reconciliation of the taxable income of the company in comparison to one or more previous income tax provisions, and
a Checks and Balances tab element for displaying when actuated selected portions of the tax return of the company to ensure that certain aspects thereof are reconciled.
